(19) United States
(12) Patent Application Publication
(10) Pub. No.: US 2008/0176197 A1
(43) Pub. Date: Jul. 24, 2008

(54) TECHNOLOGY-ENHANCED ASSESSMENT SYSTEM AND METHOD

(76) Inventor: Sandra B. HARTOG, Brooklyn, NY (US)

Correspondence Address: ARENT FOX LLP, 1050 CONNECTICUT AVENUE, N.W., SUITE 400, WASHINGTON, DC, 20036, US

(21) Appl. No.: 12/015,389

(22) Filed: Jan. 16, 2008

Related U.S. Application Data
(60) Provisional application No. 60/880,385, filed on Jan. 16, 2007.

(51) Int. Cl. G09B 19/00

(52) U.S. Cl. 434/236

(57) ABSTRACT

A network-based or standalone, scalable, affordable, standardized, easy to administer and geographically independent virtual assessment environment for performing staff selection, assessment, evaluation and promotion. Individuals undergoing assessment perform simulated job responsibilities in a simulated work environment designed to replicate elements of actual job challenges, work environment, and corporate culture. Trained assessors observe the assessed individuals' performance in real time, and provide evaluation and analysis information on-line to potential employers.

### RELATED APPLICATIONS

This application claims the benefit of U.S. Provisional Application Ser. No. 60/880,385 filed Jan. 16, 2006, titled TECHNOLOGY-ENHANCED ASSESSMENT SYSTEM AND METHOD, the entirety of which is incorporated by reference herein.

### BACKGROUND OF THE INVENTION

1. Field of the Invention

The present invention is directed to a technology-enhanced assessment system and method, and specifically, to a system and method for performing staff selection, assessment and promotion, within a virtual assessment environment via realistic and systematic simulation practices.

2. Description of the Related Art

The cost of staffing is one of the most significant costs in business today. Consistent with best business practices is hiring the best available employee for each available position and keeping good employees employed with the company for substantial periods of time. However, it is difficult to determine from reading a resume and conducting a series of interviews who is the best-suited individual for a given position or how to keep good employees, while satisfying their growth potential and professional goals.

A major demand for new employees stems from the need to replace employees that have left the job. Employee turnover is expensive due, in part, to the need to search for, relocate, and train new employees. In addition, identifying job candidates of superior talent and high qualifications is one important factor developing and maintaining a strong work force. Furthermore, the ability to quantitatively assess a candidate's likelihood of success in a particular role can lead to more informed and effective hiring practices. Good hiring practices, in turn, can lead to significant reduction in employee turnover. For example, finding the right person for a given position, and having knowledge of employees' strengths and weaknesses by performing periodic employee assessments, may increase employees' job satisfaction and performance, and reduce costly turnover.

There are known in the art on-site assessment centers, many of which use scientifically based methods for staff selection, promotion, identification of high-potential employees, and other talent management purposes. These on-site centers often use trained psychologists and other specialists to perform on-site staff assessment and evaluation. The assessors meet face-to-face with the individuals being assessed, conduct behavioral assessments and simulations of various aspects of the job, and provide a recommendation to the employer, depending on whether the individual is an external selection candidate, or a candidate for internal promotion and/or other development. One drawback of these traditional on-site assessment centers, however, is that they are typically limited to the specific geographic area where the assessment services are provided. Further, many of the on-site assessment centers often perform assessment procedures that are not systematic or standardized, and therefore frequently provide inconsistent quality of service.

There is a need in the art, therefore, for methods and systems for performing staff selection, assessment, evaluation and promotion, which are scalable, affordable, uses standardized and systematic processes, are easy to administer, and are geographically independent. There is a further need in the art for methods and systems for performing staff selection, assessment, evaluation and promotion that use web-based technology as a delivery vehicle.

### SUMMARY OF THE INVENTION

Embodiments of the present invention solve the above identified needs, as well as others, by providing enhanced methods and systems for performing staff selection, assessment, evaluation and promotion, which are scalable, affordable, use standardized and systematic processes, are easy to administer, and are geographically independent. One embodiment of the present invention provides a virtual assessment environment for performing staff selection, assessment, evaluation and promotion in a real-world employment situation, using web-based technology as a delivery vehicle.

To provide these and other features and advantages, enhanced methods and systems for performing staff selection, assessment, evaluation and promotion are provided, in embodiments of the present invention including, among other features: features for simulating an actual work environment and actual job responsibilities, in which participants perform the simulated job responsibilities in the simulated work environment; features for integrating role plays, work challenges, tests, and assessment tools in a realistic web-based simulation; features for observing and evaluating participants' performance; and features for providing evaluation results to participants and employers. In one embodiment, all of the features are location independent, and may be performed regardless of the geographic location of the employee and/or employer. The simulations of various embodiments of the present invention are designed to replicate important elements of actual job challenges, work environment, and corporate culture. Candidates participating in the systems and methods of some embodiments of the present invention “test drive” a job as employers and trained assessors observe and evaluate candidates' performance. Strengths and development needs identified during the assessment can then be used to select and/or develop high quality employees.

According to one embodiment of the present invention, there is provided a virtual assessment environment, including a website or other network site, which may be accessed to perform staff selection, assessment, evaluation and promotion.

In one embodiment of the present invention, the user is observed and evaluated by trained assessors, and one or more evaluation reports are electronically generated by entering evaluation data into forms provided on the site. The assessment may include, for example, role-playing activities, in which the user interacts with others in simulated business situations. The role-plays may be conducted via email, telephone, or in person. The role-play activities may be included in the user's electronic in-basket, or may be unscheduled. The user may be observed and evaluated by trained assessors while performing the role-play activities, and evaluation data from the role-play activities may be included in the integrated evaluation data.

The system and method of some embodiments of the present invention provide features by which employers can significantly increase their effectiveness in finding and hiring extraordinary talent by allowing the employers to observe candidates' operating styles. Direct observation of a candidate's behavior provides employers with more insight into the potential employee than merely listening to the candidate describe what he/she has done in the past and may do in the future. Direct observation further allows employers to identify superior talent, which may not be apparent in a typical interview situation. Thus, embodiments of the present invention may prevent a talented individual's strengths from being overlooked in a potential hiring situation, thereby allowing an employer to hire a workforce of high-potential talent.

In addition, embodiments of the present invention allow a potential employee to “test drive” a job or new skill set prior to taking the job or new responsibilities. Thus, the potential employee gains a realistic understanding of a new position prior to accepting the position. The potential employee may then enter into the position with realistic expectations. Also, by assessing the candidate's “test drive” of the position, an employer can more realistically determine the candidates' potential to be successful in the position. Hence, more enlightened employment acceptance and hiring decisions may be made by all parties, which may lead to greater job satisfaction, success, and retention. The system and method of some embodiments of the present invention may also be used to evaluate current employees, in addition to potential future employees.

Embodiments of the present invention allow employers to identify employee candidates' individual strengths and development needs as part of an “on-boarding” or hiring process, thereby allowing employers to prepare existing employees and create actionable development plans.

The technology-enhanced assessment of various embodiments of the present invention is scalable, transportable (can be performed across diverse geographic areas), easily administered, and requires few resources. The simulated assessment environment of some embodiments of the present invention may be centrally controlled with local implementation anywhere in the world having an Internet connection and a telephone line. Hence, the assessment is cost-effective. Furthermore, the assessment may be easily customized and quickly implemented depending on a client's needs. By providing the ability to effectively select and place new employees, embodiments of the present invention may significantly reduce employee turnover.

Other objects, features, and advantages will be apparent to persons of ordinary skill in the art from the following description of the invention and the accompanying drawings.

### BRIEF DESCRIPTION OF THE DRAWINGS

In the drawings:

FIG. 1 presents an exemplary diagram of an open system architecture, on which an embodiment of the present invention is based;

FIGS. 2A-2E illustrate exemplary Graphic User Interface (GUI) screens representing various system components, in accordance with one embodiment of the present invention;

FIG. 3 shows an example flow diagram of functions performed in accordance with an embodiment of the present invention;

FIG. 4 illustrates a flow chart showing an overview of an assessment process according to an embodiment of the present invention;

FIGS. 5A to 5V illustrate sample GUI screens for an exemplary web-based orientation, in accordance with one embodiment of the present invention;

FIGS. 6A and 6B show an exemplary on-line database for use in accordance with one embodiment of the present invention;

FIG. 7 illustrates a block diagram of various computer system components for use in an exemplary implementation of an embodiment of the present invention; and

FIG. 8 illustrates a system and components for implementing an embodiment of the present invention over a network.

### DETAILED DESCRIPTION OF THE INVENTION

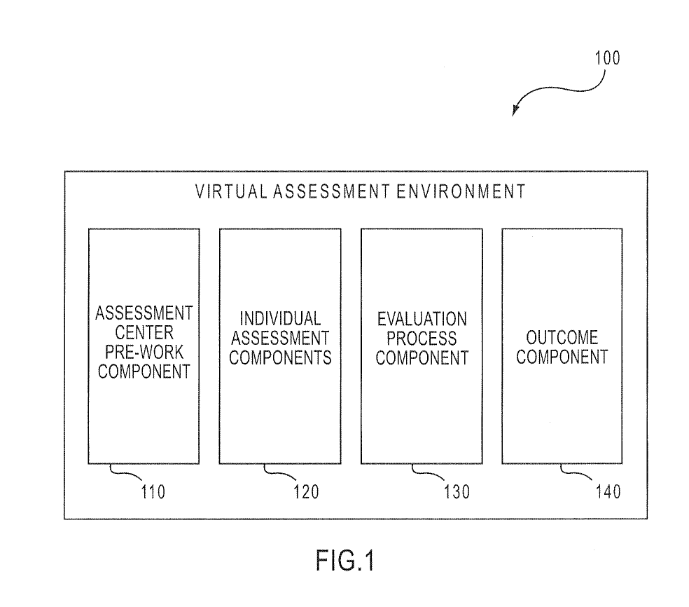

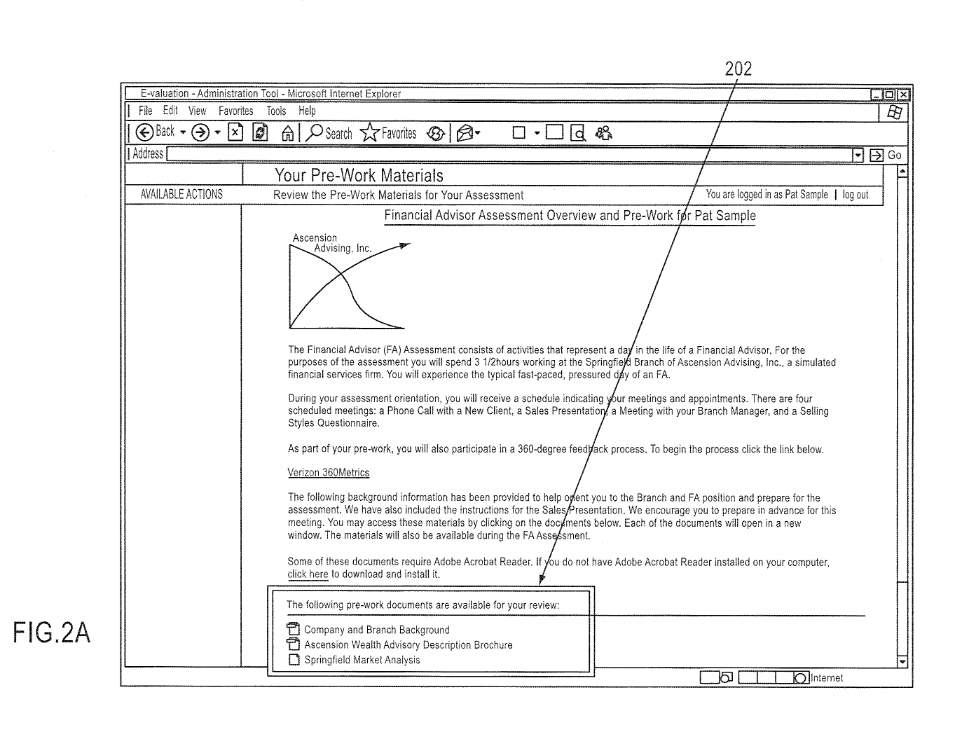

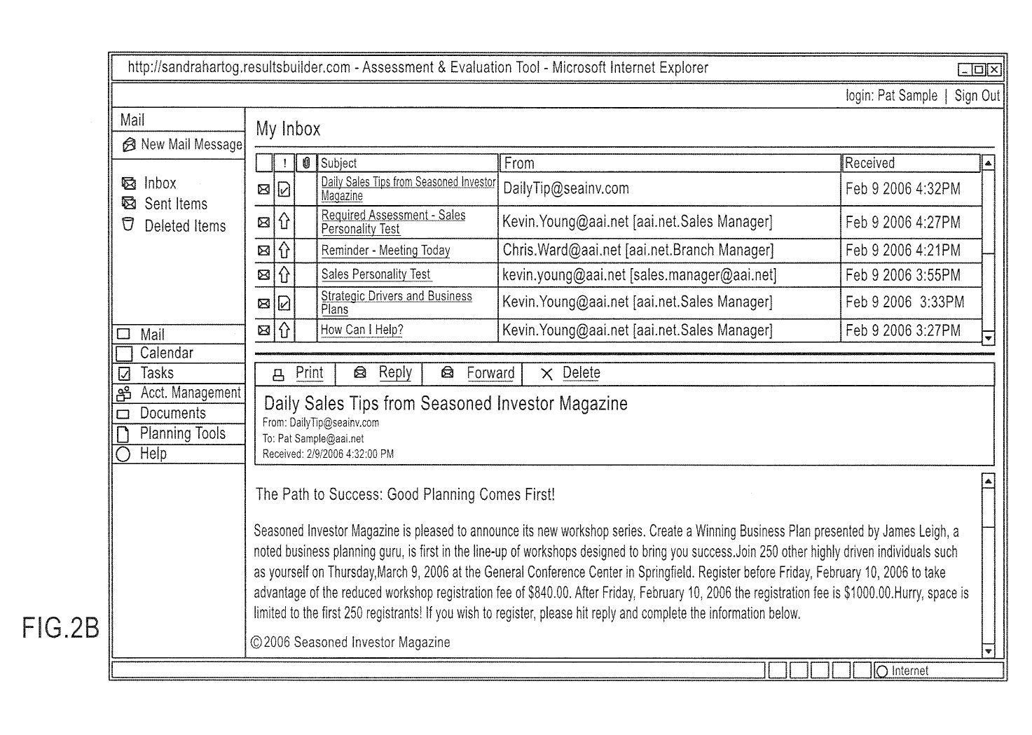

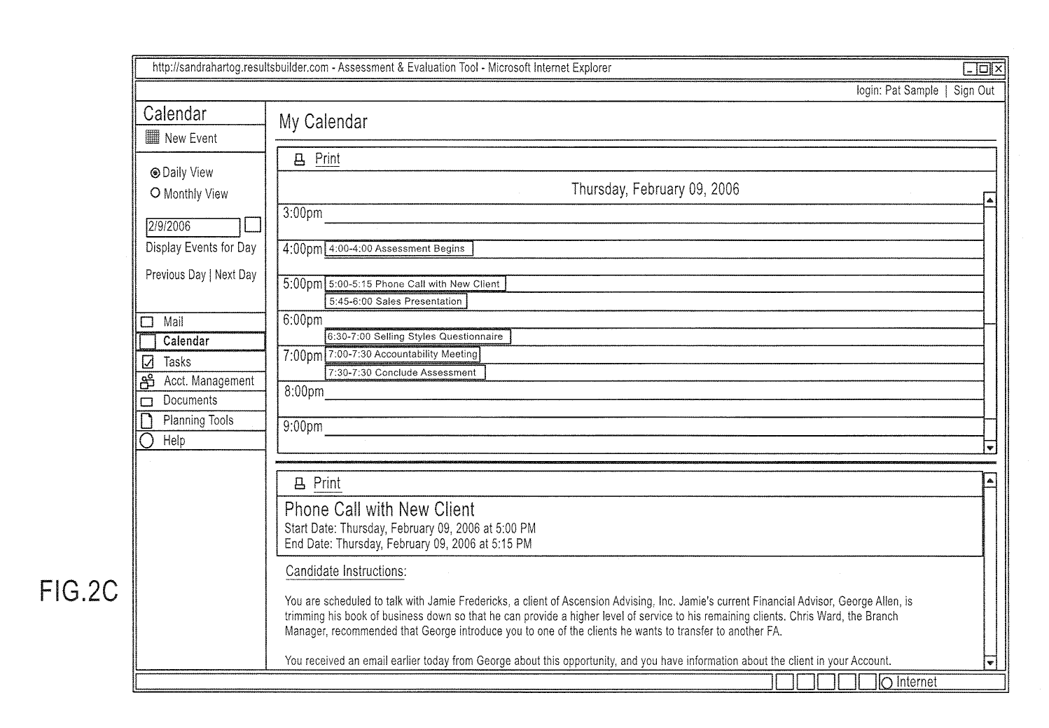

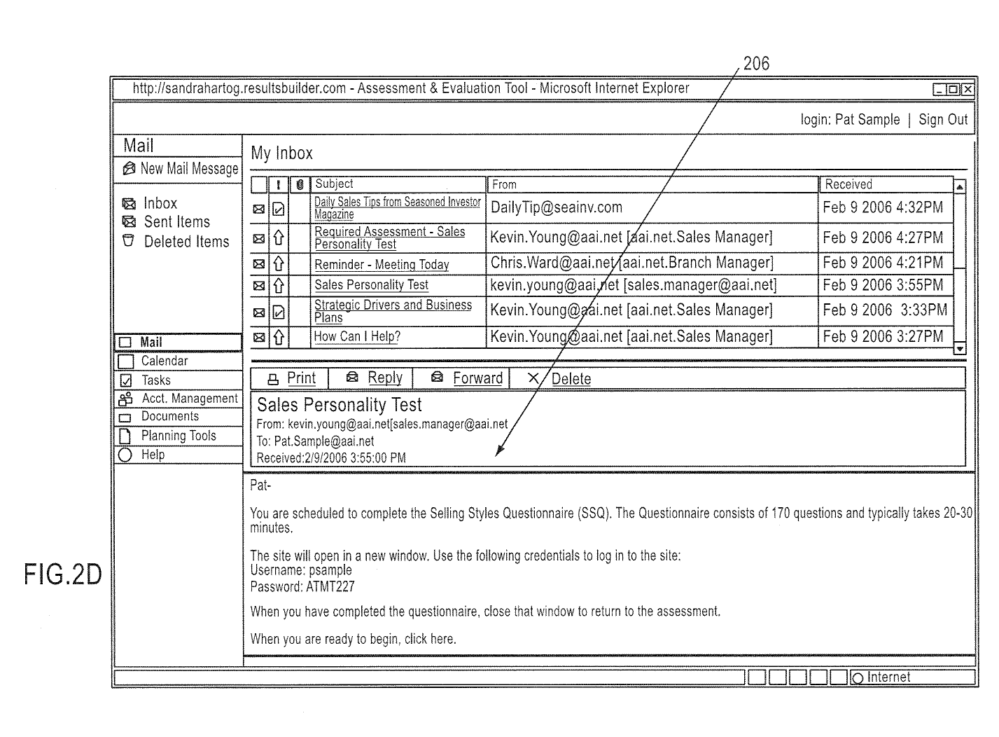

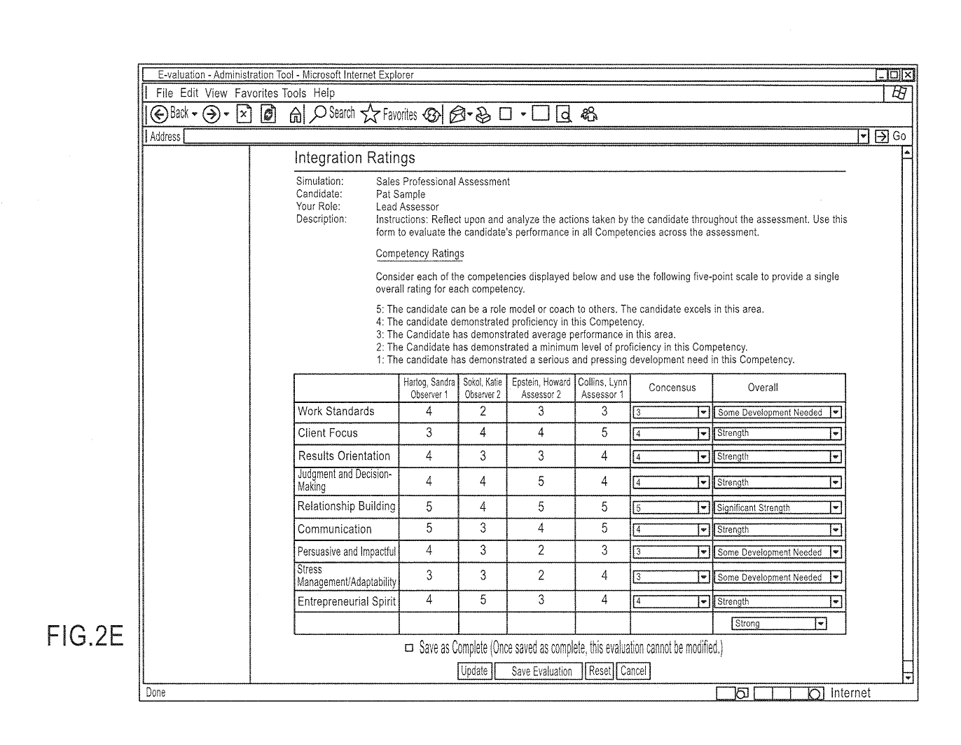

Referring now to FIG. 1, therein shown is an exemplary diagram of an open system architecture, on which an embodiment of the present invention is based. A virtual assessment environment 100 is provided to create a realistic simulation of a typical day that may be experienced by a professional in a certain field (e.g., for the position for which the individual is being assessed). Virtual assessment environment 100 may be created, for example, via web-based assessment exercises and supporting background materials, and opportunities to interact with others. Within the Assessment Center Pre-Work Component 110, the assessed individual (interchangeably referred to herein as a participant or candidate) may submit, via a web-based interface, a Career Accomplishments Profile, a resume and other pre-testing materials. In addition, the participant may review assessment preparation materials, which typically may include: simulated company and market background information, the position description and, optionally, instructions for in-person role play with third party assessors. The Assessment Center Pre-Work Component 110 may include additional elements, such as a structured career/background interview and a personality test. An exemplary GUI screen showing the web-based interface for the Assessment Center Pre-Work Component 110 is shown in FIG. 2A, with pre-work documents 202 available for the participant's review.

Referring again to FIG. 1, the Individual Assessment Component 120 may include the following elements: independent work on in-basket tasks; telephone and/or face-to-face role plays; other scheduled and/or unscheduled interactions; personality and/or cognitive testing; and a debrief interview with the participant and wrap-up. A role is designed for the participant as an employee in a position for which the employee is being considered by an employer (herein also referred to interchangeably as a “client”). The candidate being considered may already be an employee of the client, or may be a potential new hire. In any event, the candidate “works” for a day within the simulated organization in the designated role. The candidate takes part in the simulation by performing job-related duties presented throughout the simulation. Role plays, work challenges, tests, and other assessment tools, which may be provided over a computer network, for example, are used to effectively replicate elements of the actual job responsibilities, work environment, and culture. The job-related tasks and activities presented to the participant throughout the day by the simulation may be designed to ascertain the participant's level of skill in the field to which the simulation is directed, for example. Trained assessors observe and evaluate the candidate's performance throughout the simulated work-day and provide valuable feedback to the employer considering the candidate for a position and, optionally, to the candidate.

An exemplary GUI screen of an in-basket exercise is shown in FIG. 2B. In the example shown in FIG. 2B, a participant is responding to action items that are housed in a computer simulated email inbox, for example. The action items 204 may require the participant to demonstrate various skills and abilities, such as customer focus, logic and reasoning, timely and quality decision making, planning, innovation, strategic thinking, vision, learning agility, and communication, among others.

An exemplary GUI screen of a role-play exercise is shown in FIG. 2C, in which a participant confronts typical situations faced by an individual in the position for which the participant is being assessed, through a series of role play simulations. Role plays can include scheduled and unexpected interactions with typical and frequent manager contacts (e.g., clients, direct reports and Senior Management). Each role play may be evaluated by trained assessors using online competency-based evaluation forms.

An exemplary GUI screen showing the web-based interface for the Individual Assessment Component 130 is shown in FIG. 2D, in which the participant is scheduled to take a Sales Personality Test, as indicated at 206. In addition, the participant may complete further personality and cognitive tests that provide additional information related to the competencies required for the position (e.g., critical reasoning, conscientiousness, emotional intelligence, analysis, learning agility, and problem solving).

During the assessment, assessors and/or third parties, such as a potential employer, may perform interactive roles with the participant in order to simulate job-related experiences requiring personal interactions. The participant may also interact with third parties via a computer and/or telephone, for example. The third parties may be real people interacting with the participant from anywhere in the world over a network and/or telephone system, or the third parties may be simulated individuals, such as simulations programmed on a computer, or a combination of the two. Thus, the enhanced assessment may be performed at any location around the world that has access to a computer, the Internet, and/or a telephone. The assessment may be performed at the offices of an employer considering the candidate, for example, in a proctored environment, and the potential employer and representatives thereof can observe and/or participate in the assessment to the extent desired. In addition, because the method and system for enhanced assessment in accordance with various embodiments of the present invention allow the assessment process to be performed in multiple locations at the same time, multiple assessors and/or raters may be used to evaluate multiple participant actions, thereby providing a comprehensive assessment of the candidate(s). Moreover, multiple candidates may take part in the simulation simultaneously.

If the assessment is conducted entirely via telephone and/or the Internet, for example, individuals taking part in assessment process, including the candidate, assessors, potential employer(s), and others, may participate from anywhere in the world, thereby reducing or eliminating hard and soft costs, such as travel, lodging and entertainment costs, vendor costs, administration, and time away from work. Even if the assessment is conducted by technology delivery coupled with face-to-face and/or telephone role-plays, the expenses of such an assessment may still be reduced. Thus, the technology enhanced assessment of the present invention can be conducted at minimal cost to the client.

Referring again to FIG. 1, Evaluation Process Component 130 may include such elements as assessment of strengths, areas for development, and participant ratings and recommendations. The trained assessors evaluate participant performance against role-specific competency models, and create competency-based feedback and evaluation reports that can then be used to create actionable development plans.

In accordance with one embodiment, assessors are responsible for submitting assessment evaluations for each activity they observe. Evaluations may be captured in real time via online evaluation forms, for example, and may be immediately available for viewing by stakeholders (e.g., the potential employer). In one embodiment, assessors are certified in performing the enhanced assessment techniques.

Prior to the assessment conclusion, assessor(s) may interview the participant to gain additional insight regarding the participant's actions throughout the assessment center exercises. The participant's rationale for choices made during the exercises provides valuable insight into the participant's operating and learning style, behavior, and personal understanding of the participant's strengths and weaknesses.

In accordance with one embodiment, assessors are responsible for: compiling and evaluating the assessment information; for integrating their findings with other assessors; and for providing a report with an overall recommendation and competency analysis. In accordance with one embodiment, one or more lead assessors may be responsible for quality control and assessment consistency across business units and job titles.

Referring again to FIG. 1, Outcome Component 140 may include such elements as an assessment report, periodic feedback to the management team, and monthly/periodic quality reviews. Competency- and behavior-based reports with development recommendations may be made available via a secure website for stakeholder review, for example. In accordance with one embodiment, access to the reports may be permission-based, thereby ensuring data security. In accordance with one embodiment, the timeline for report delivery may be contingent upon report style selected and participant availability for feedback scheduling.

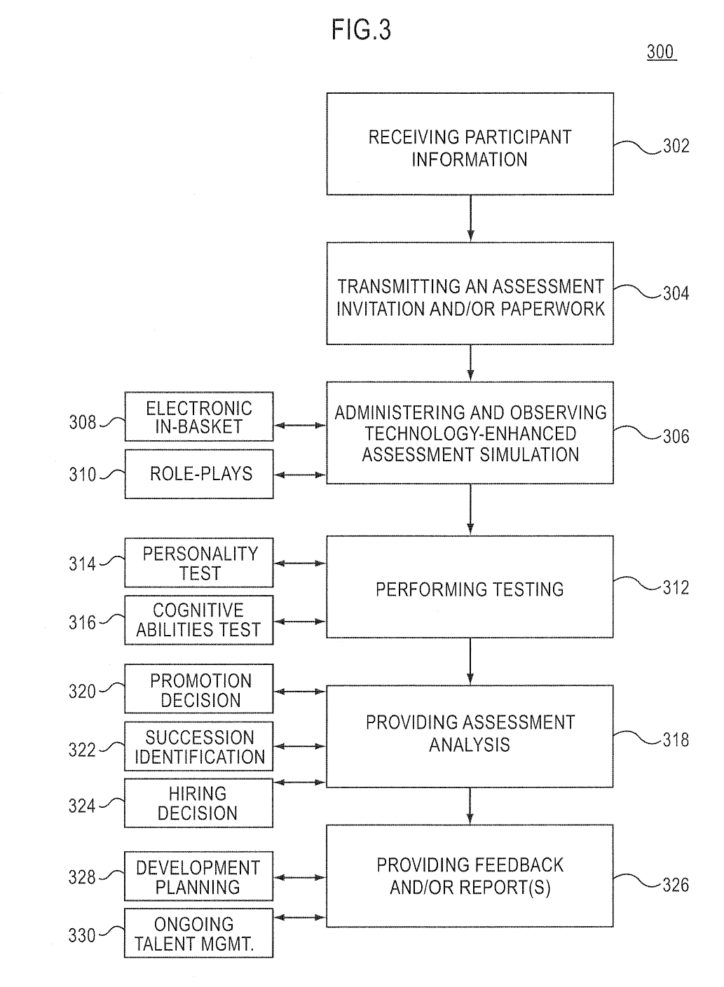

Referring now to FIG. 3, therein shown is an example flow diagram of functions performed in accordance with an embodiment of the present invention. Participant (e.g., external candidate for a position, internal candidate for a promotion) is received 302. The source for participant information may be the client (e.g., the potential employer) or another source, such as a head-hunting agency, for example. In accordance with one embodiment, the participant may be pre-screened via a telephone or in-person interview, for example.

An assessment invitation and/or accompanying paperwork is provided 304. Technology-enhanced assessment simulation including electronic in-basket 308 and/or role playing exercises 310 and other assessment techniques, may be administered and observed in real time 306. In one embodiment, administering the technology-enhanced assessment simulation 306 includes a user logging in to the virtual assessment environment using a username and password, and following pre-scripted prompts simulating an actual work environment. A web server may store observation and assessment information, including at least one database and at least one program for storing and manipulating data, for example. The data may include user specific participant data obtained through performance of the assessment 306.

In one embodiment, the at least one program includes instructions for generating, on a terminal, for example, business-related application interfaces for a business specific electronic in-basket, wherein the electronic in-basket houses action items for simulating work activities related to the specific business. By accessing the website and performing the action items provided in the electronic in-basket, the participant may experience a simulated day of conducting the specific business.

In accordance with one embodiment, the assessment simulation may include performing such actions as responding to e-mails and telephone calls, participating in business meetings, preparing business reports and evaluating employees. Testing of the participant may also be performed 312, including personality test(s) 314 and cognitive abilities test(s) 316, among others.

Behavioral analysis of the participant's strengths and weaknesses is performed 318 based on the technology-enhanced assessment simulation 306 and/or the testing 312. Assessment analysis is provided 318, which may include a promotion 320 or hiring 324 decision, and/or succession identification 322. Feedback and/or report(s) are provided 326, which may include development planning 328 and/or ongoing talent management 330.

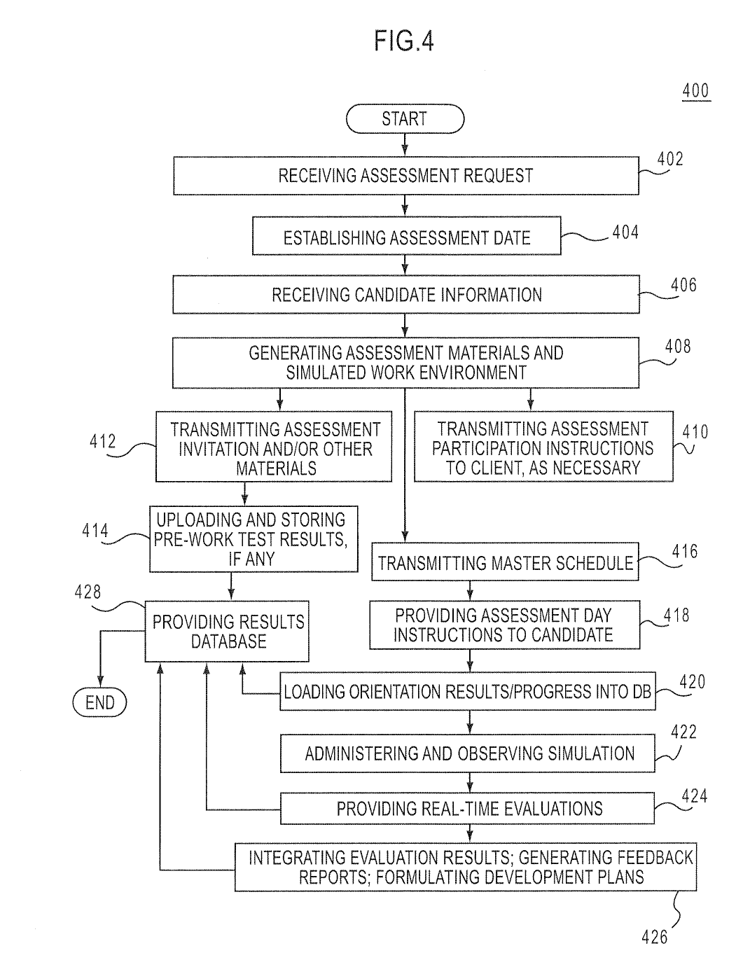

Referring now to FIG. 4, therein illustrated is a flow chart showing exemplary steps for conducting the technology enhanced assessment according to an embodiment of the present invention.

As shown in FIG. 4, an assessment request is received 402. In accordance with one embodiment, an assessment date may be established 404, and candidate data received 406. In one embodiment, a client may contact a provider of the technology enhanced assessment to describe the type of company and position for which the assessment is to be performed. The provider may collect pertinent information from the client, which may include, for example, names and contact information for desired candidate(s) and names and contact information for client participants in the assessment, if any.

In accordance with one embodiment, assessment materials and a simulated work environment are generated 408. The assessment materials may be personalized for the specific candidate and position, and the simulated work environments may be specific to the company and position, for example. In one embodiment, the assessment materials may be customized for employee selection/development for a wide range of competencies, positions, and simulations. Some portions of the assessment materials may be prefabricated, and used as is, or altered as necessary to fit the particular circumstances of the assessment, e.g., the field in which the assessment is to be conducted, etc. Thus, creation of the simulation may begin at any time, including prior to a client contacting the provider, and may continue until the assessment is conducted.

In one embodiment of the present invention, an assessment invitation and other materials are transmitted to the candidate 412. For example, the provider may invite the candidate to the assessment, via email or other means, and may provide information to the candidate regarding what to expect during the assessment and what may be gained by participation (e.g, a professional development plan, including developmental recommendations formulated for the candidate). If desired, the client may choose to contact the candidates directly instead of going through the provider. Via embodiments of the present invention, the client may be as visible or as transparent as desired with respect to the candidates and the assessment process.

In accordance with one embodiment, the provider, the client, or another party may transmit optional “pre-work” tests to the candidate, such as personality and cognitive measures that provide additional information related to the competencies (e.g., critical reasoning, conscientiousness, emotional intelligence, analysis, learning agility, and problem solving), to be completed prior to the assessment. The pre-work may be provided online, in which case the provider may send the candidate login information to access the tests, and any other information provided online. The pre-work test results, if any, may be uploaded and stored in a results database or other repository of data 414.

Assessment participation instructions may also be transmitted to client participants in the assessment process, if any 410. A master schedule may be transmitted along with other information, as necessary 416. For example, the provider may transmit a master schedule, which may include instructions for administering the assessment and login information and password(s) for candidate(s) to access the virtual assessment environment, along with assessment set up information, to a contact person for the client (hereinafter referred to interchangeably as the client administrator, administrator, or “CA”). The administrator may also be provided with “administrator” login information, to gain access to the provided results database (or other repository of data) 428, including candidate pre-work notification and password access, pre-work tracking, log of candidates in progress, contact numbers, accessibility to evaluation reports, and records of completed candidates.

In accordance with one embodiment, the client administrator may set up the candidate computers using login information from the master schedule. The client administrator may set up the candidate computers and virtual offices at any time prior to the actual assessment. Alternatively, the set up may be performed by the provider or a third party.

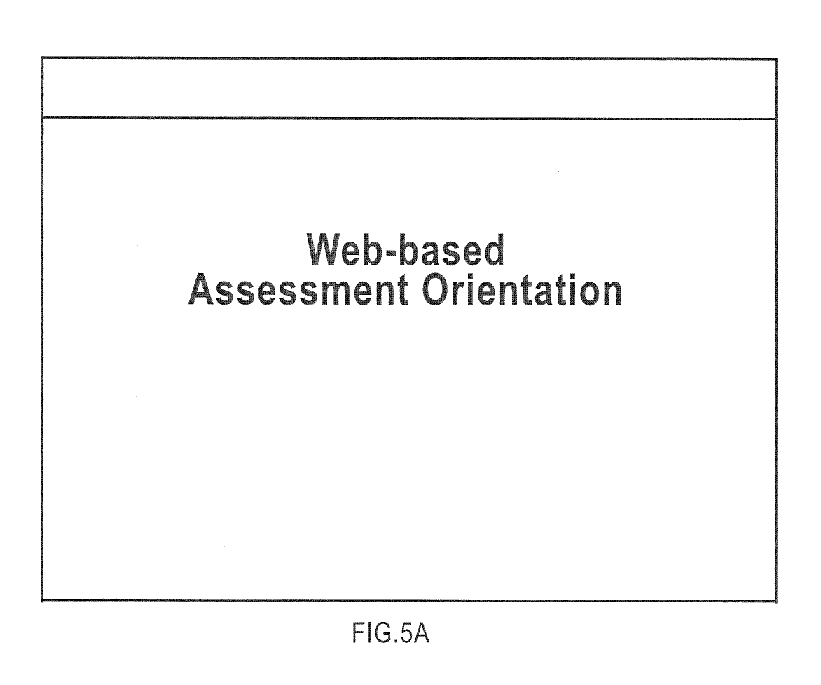

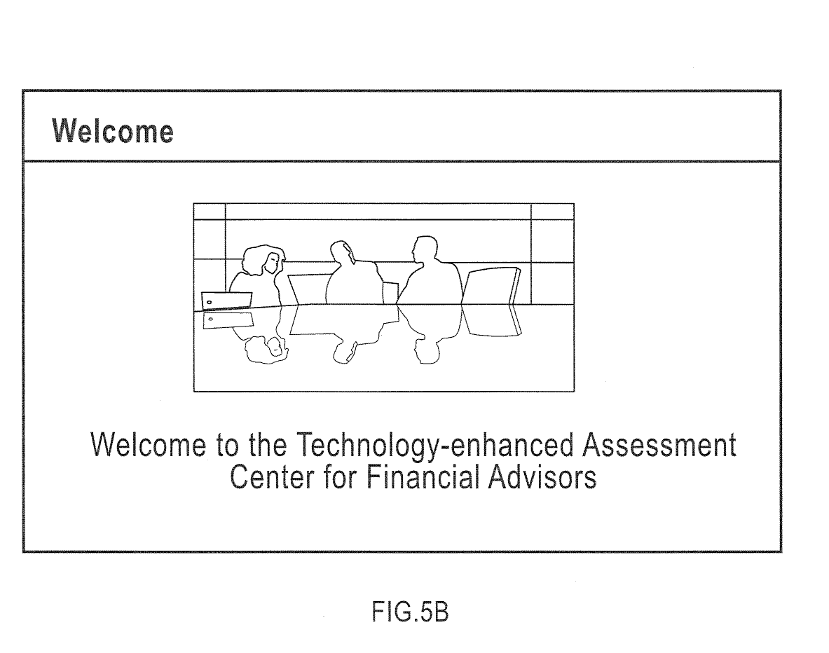

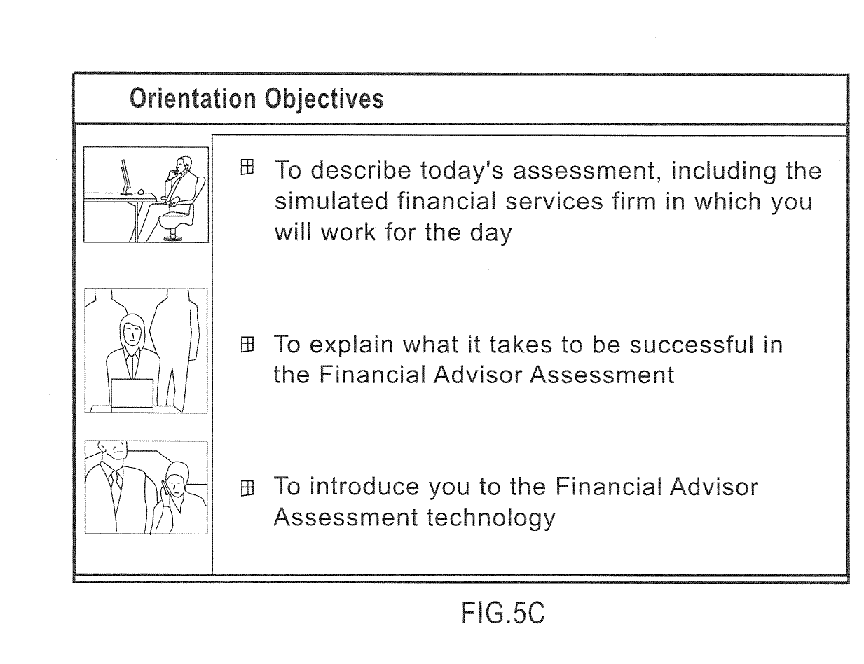

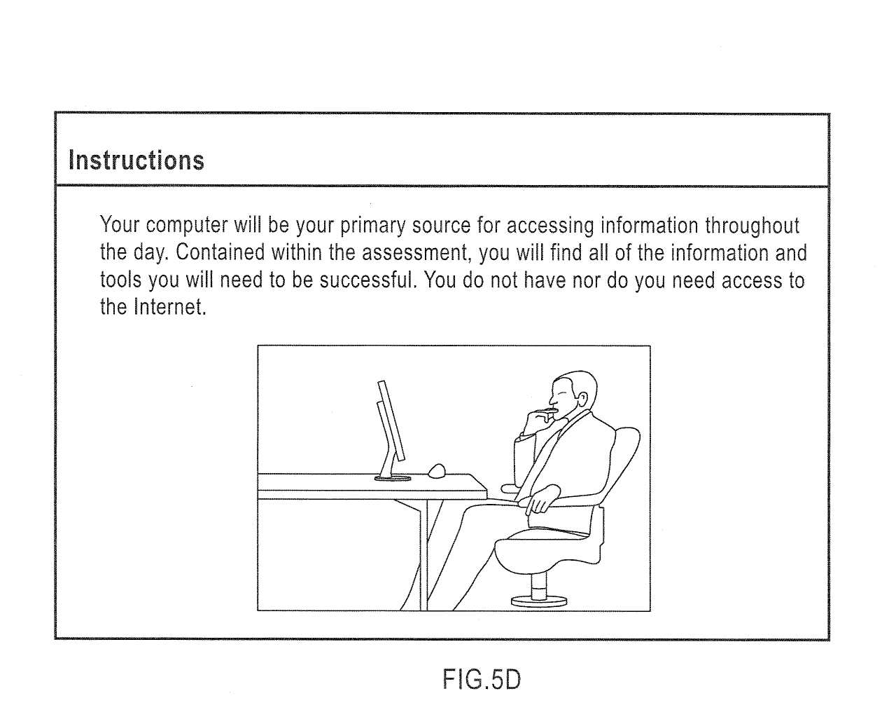

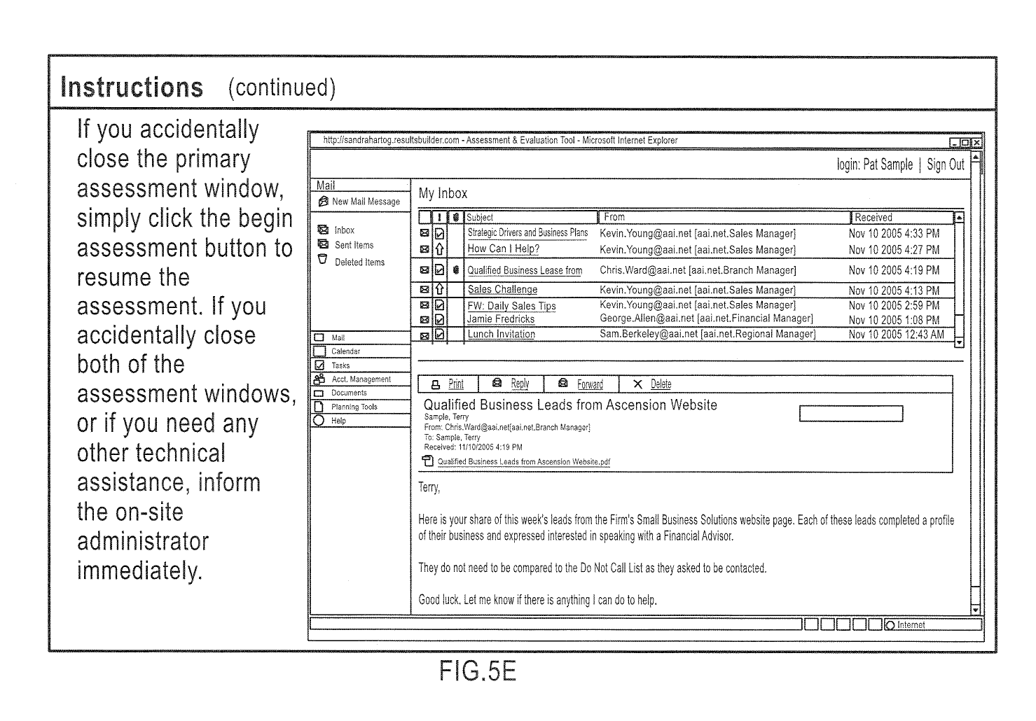

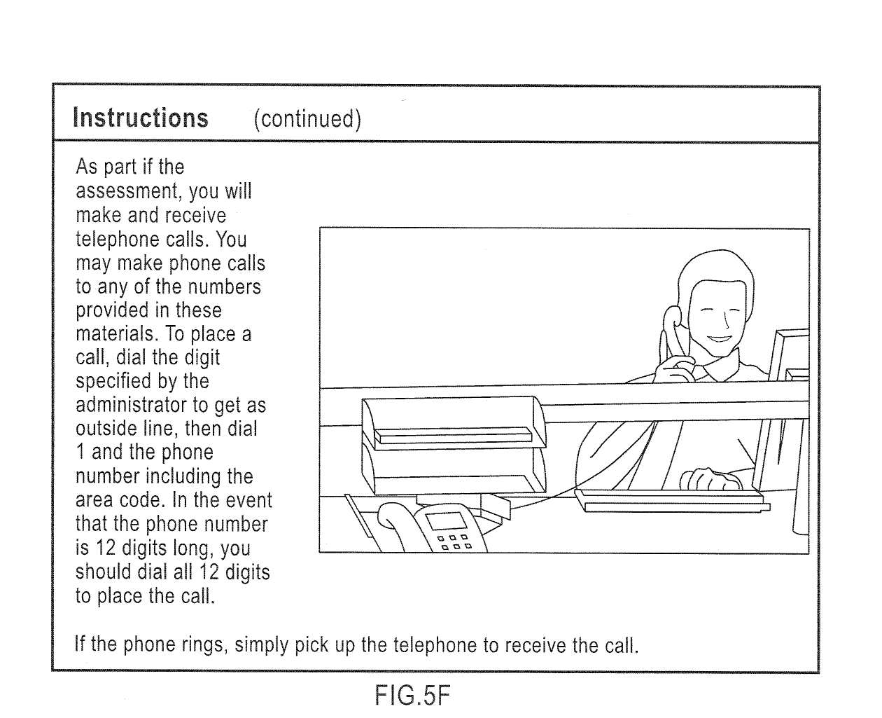

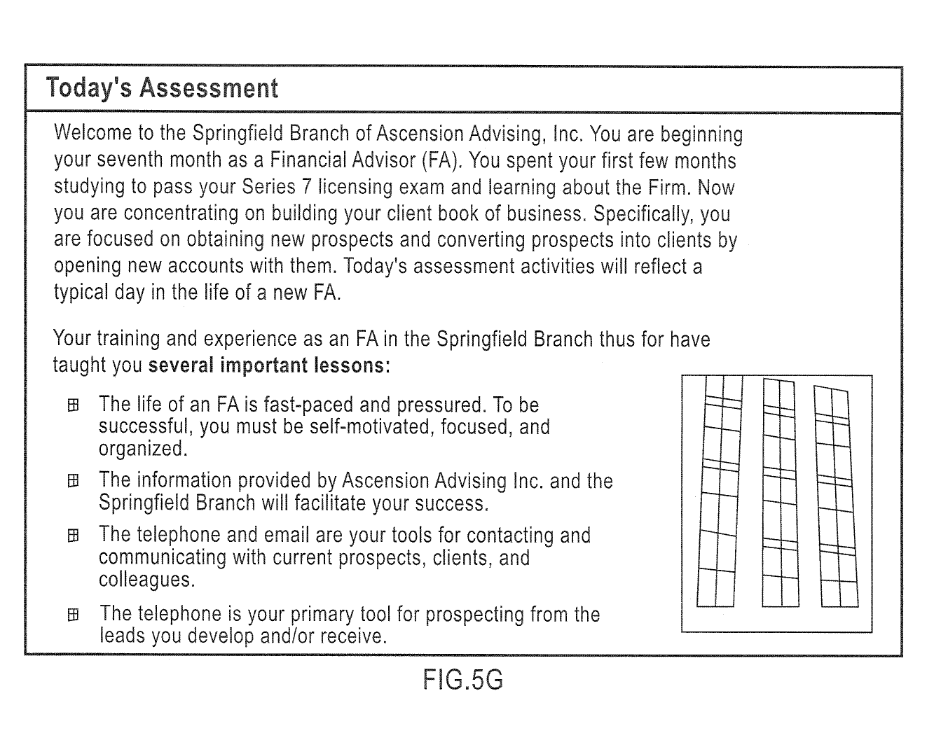

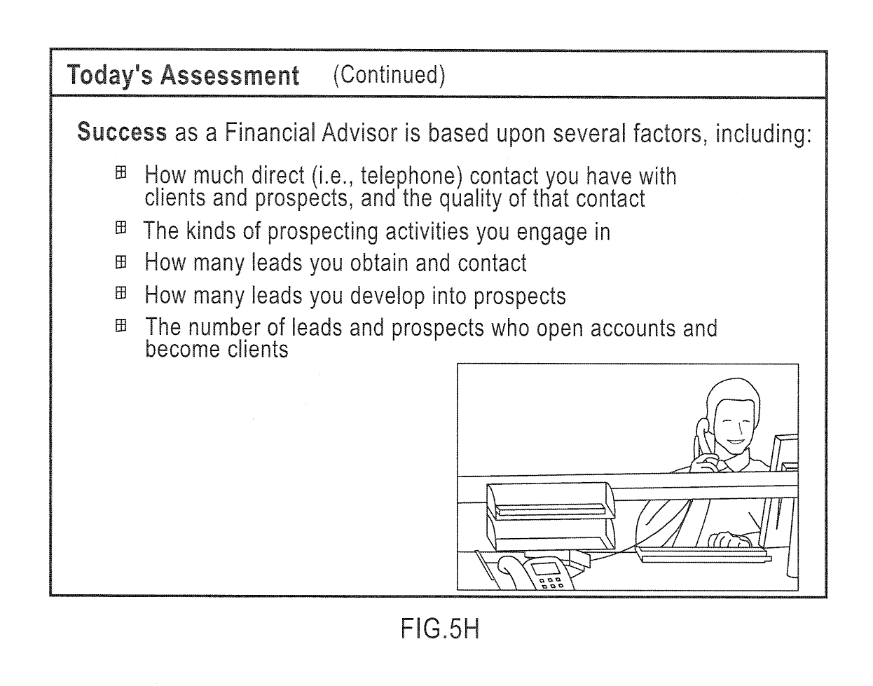

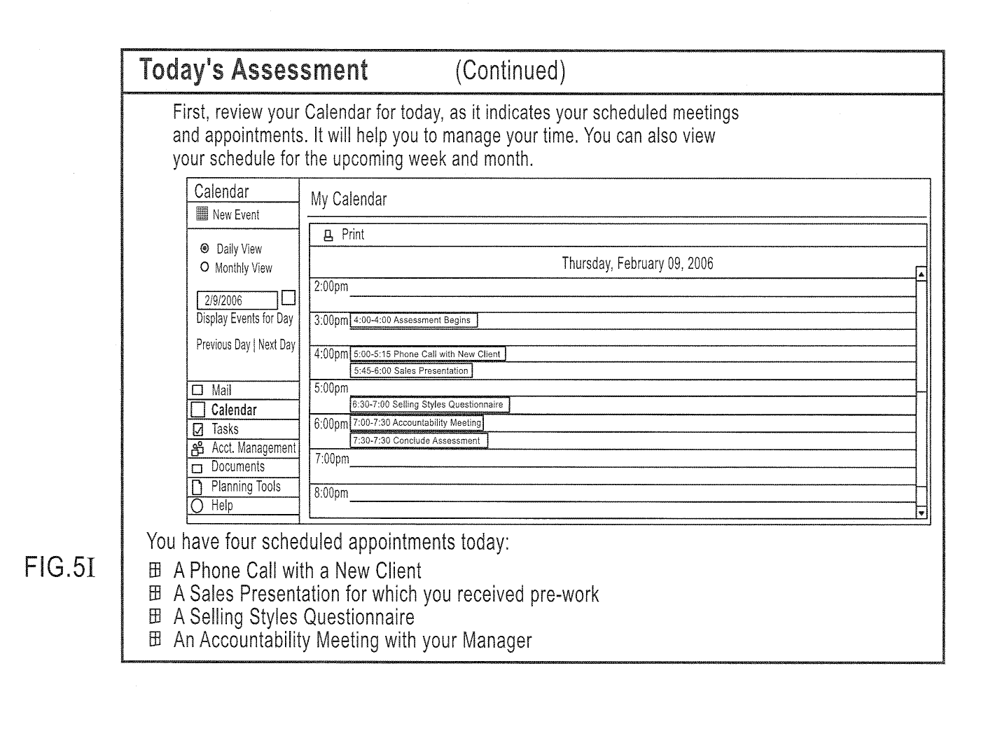

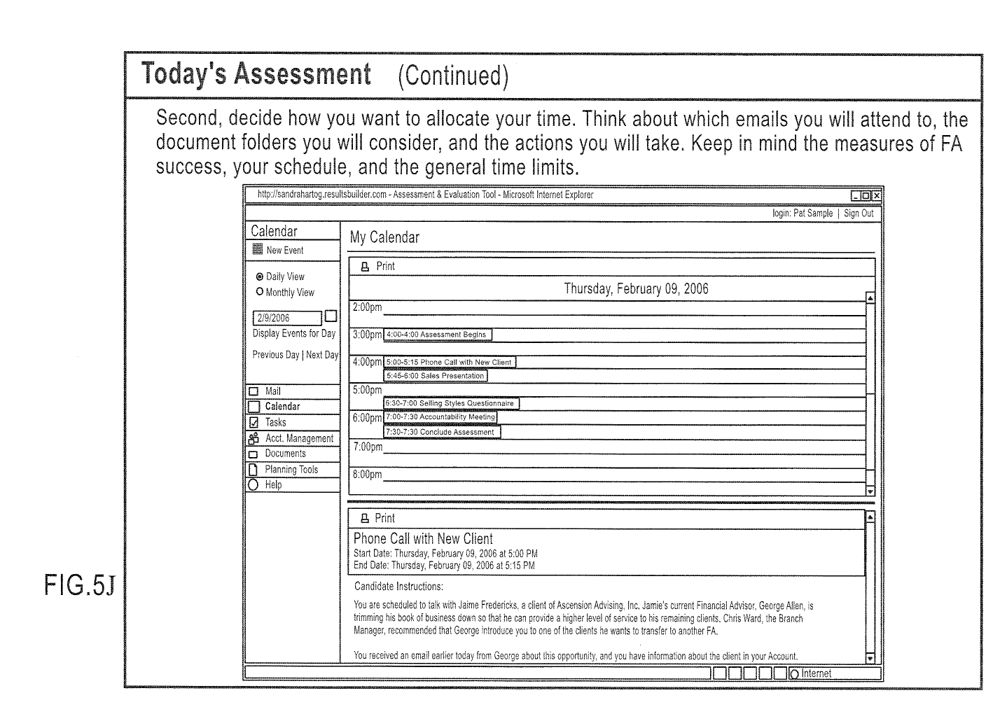

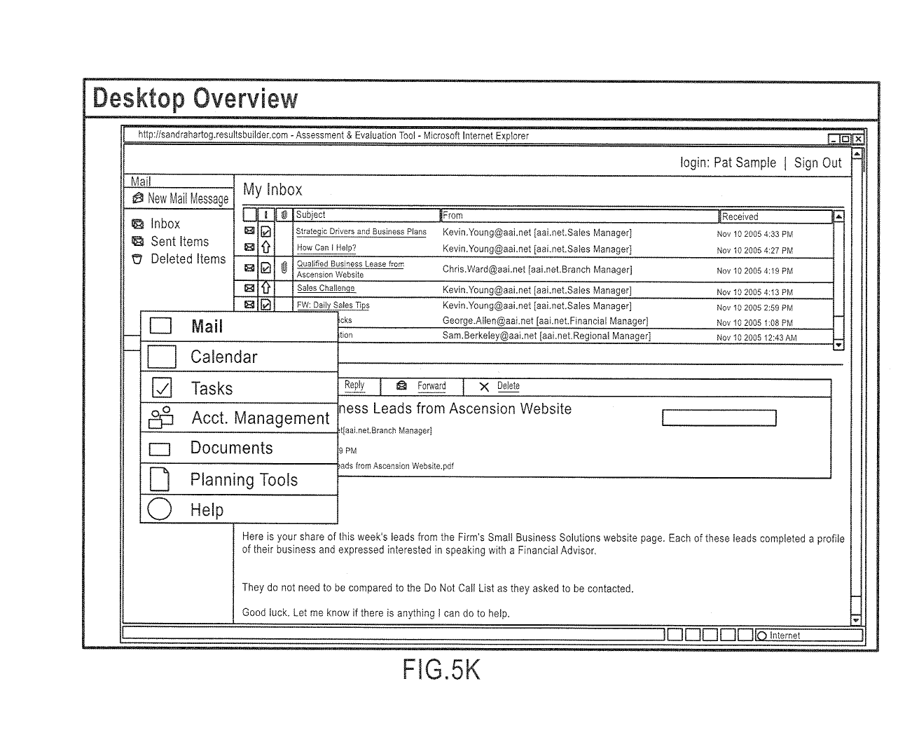

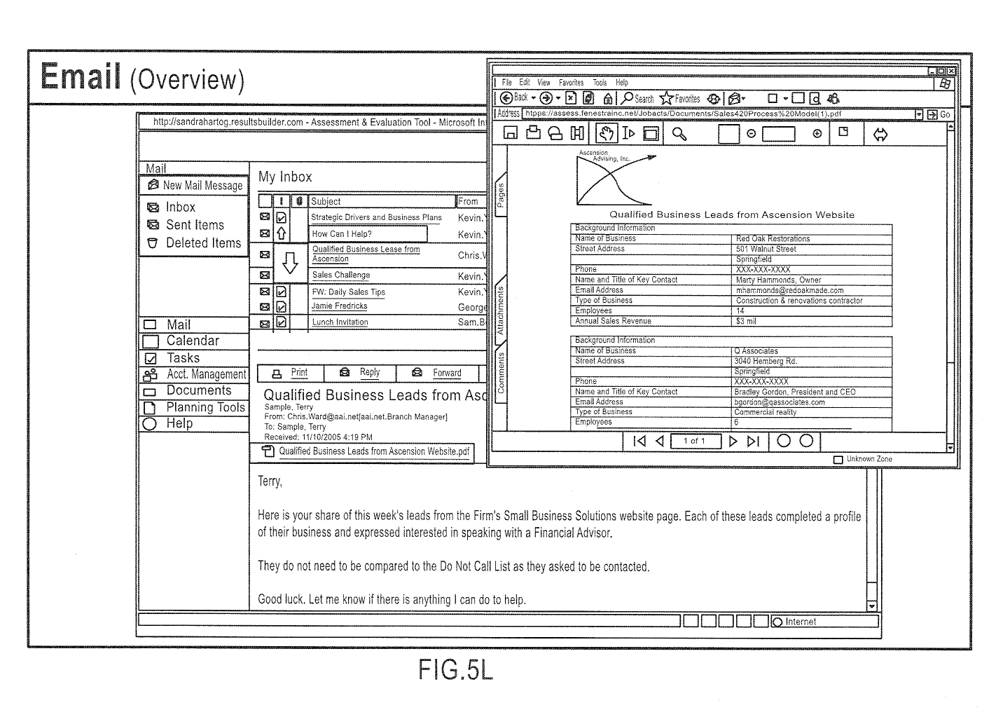

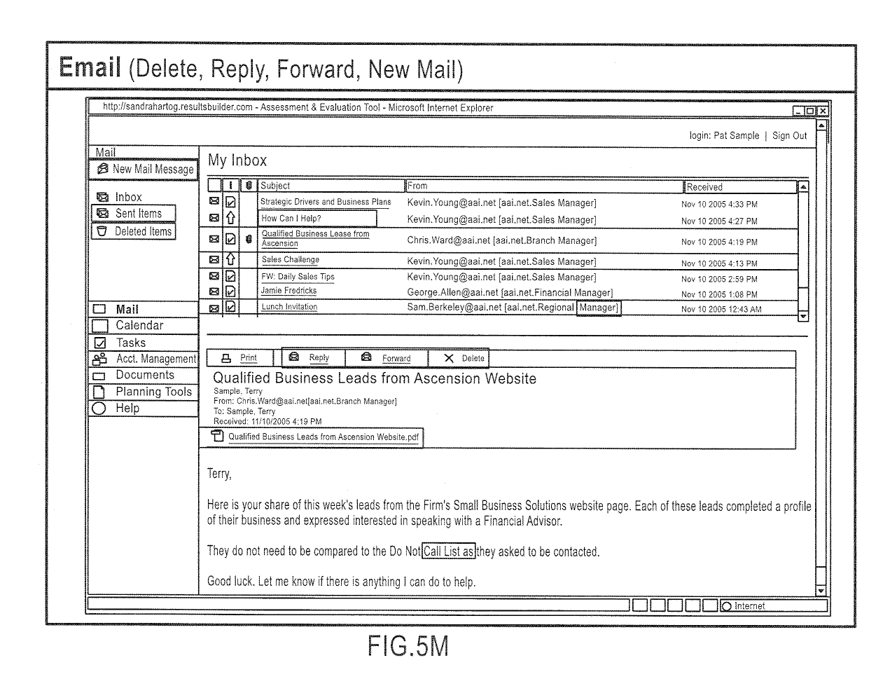

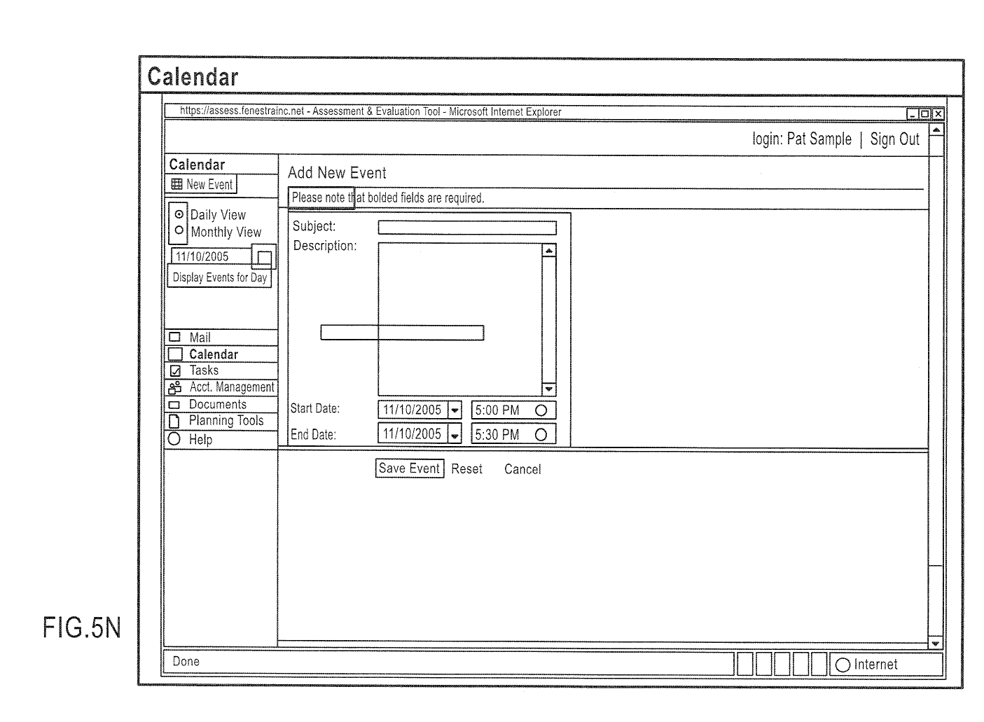

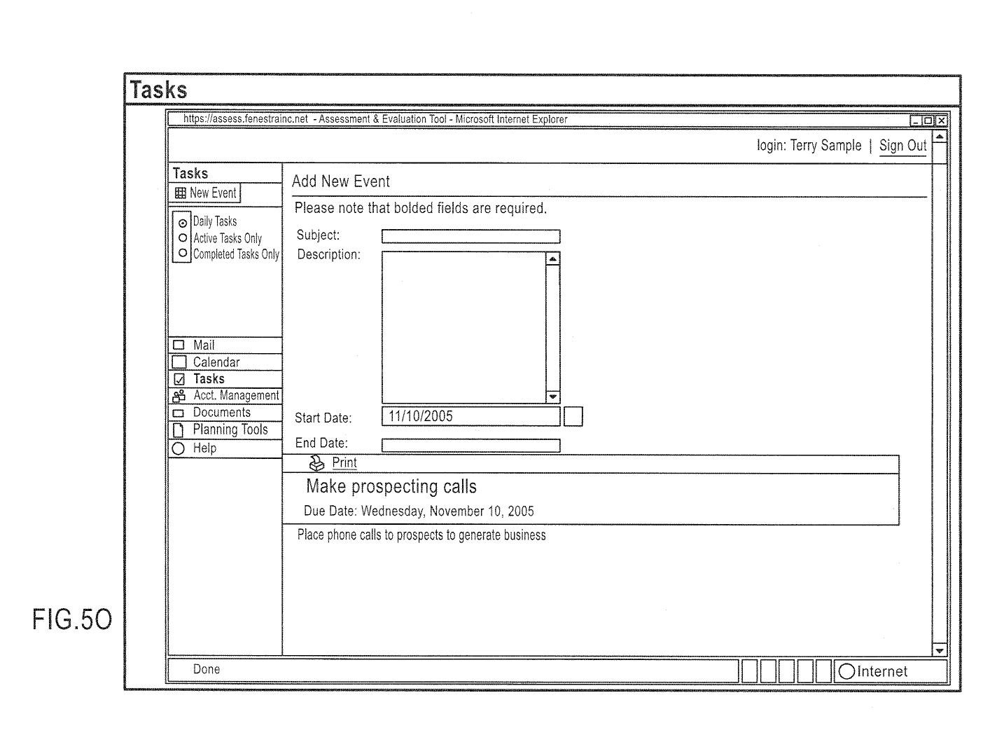

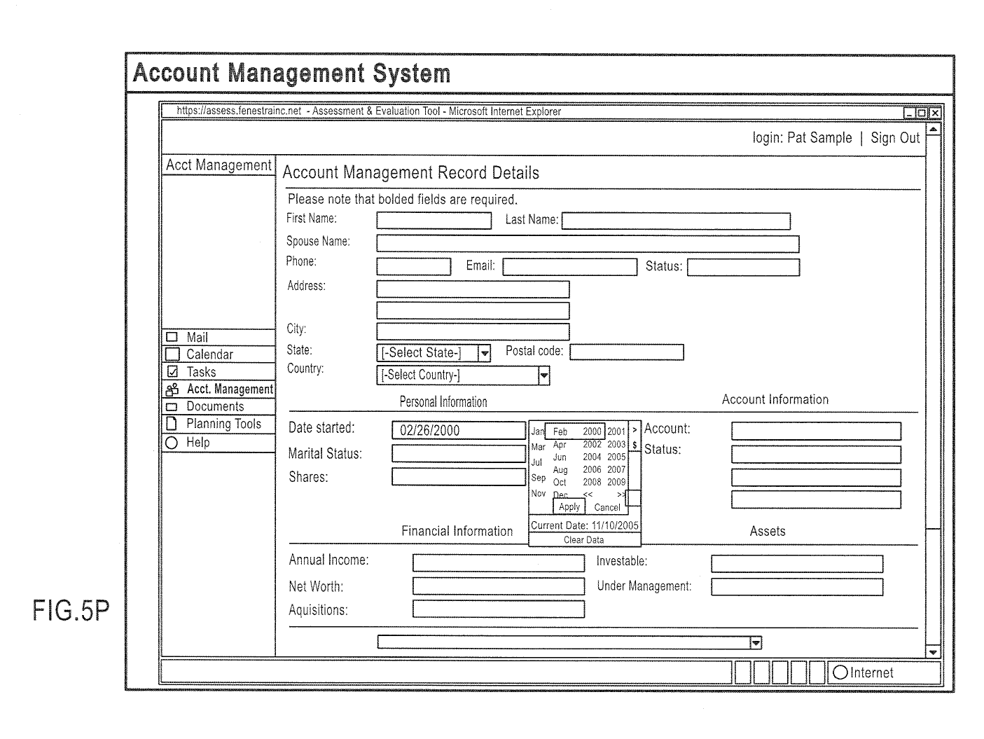

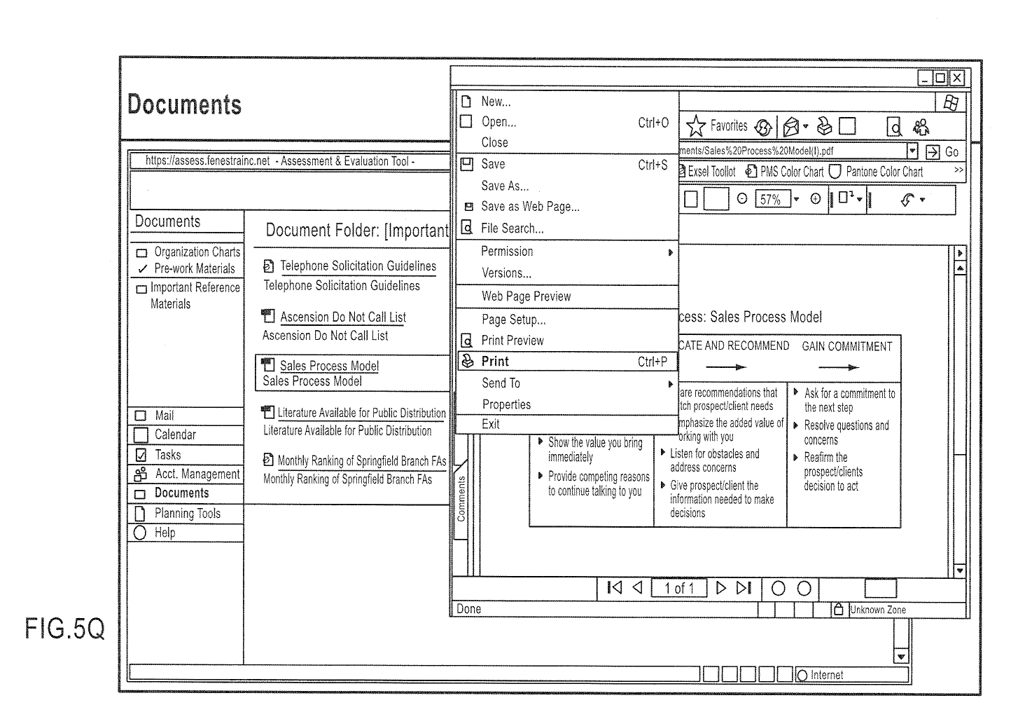

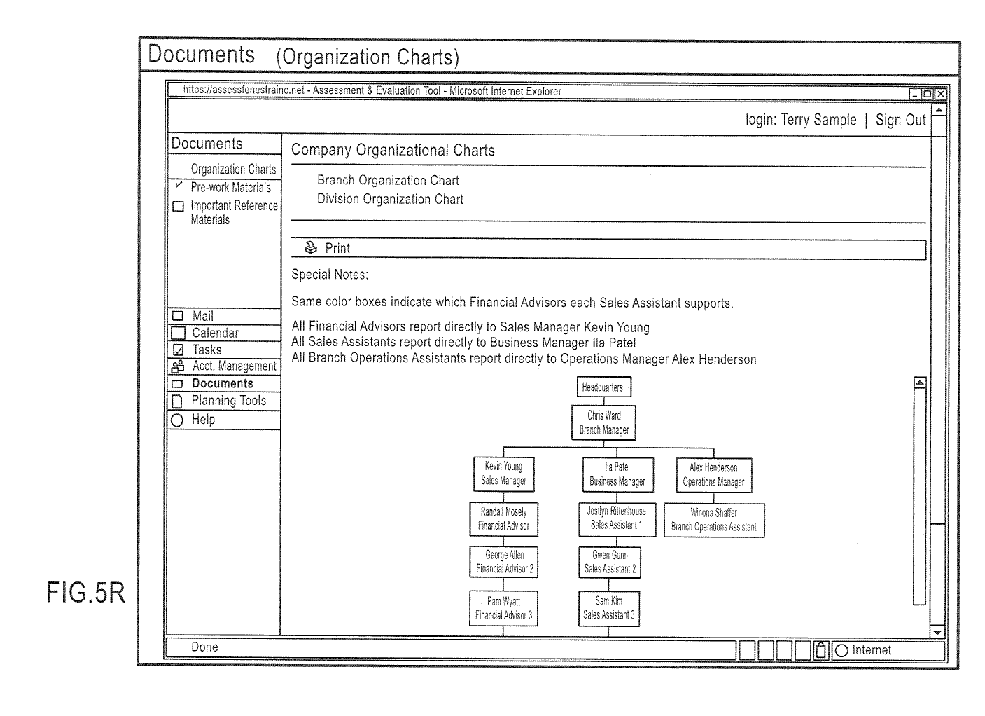

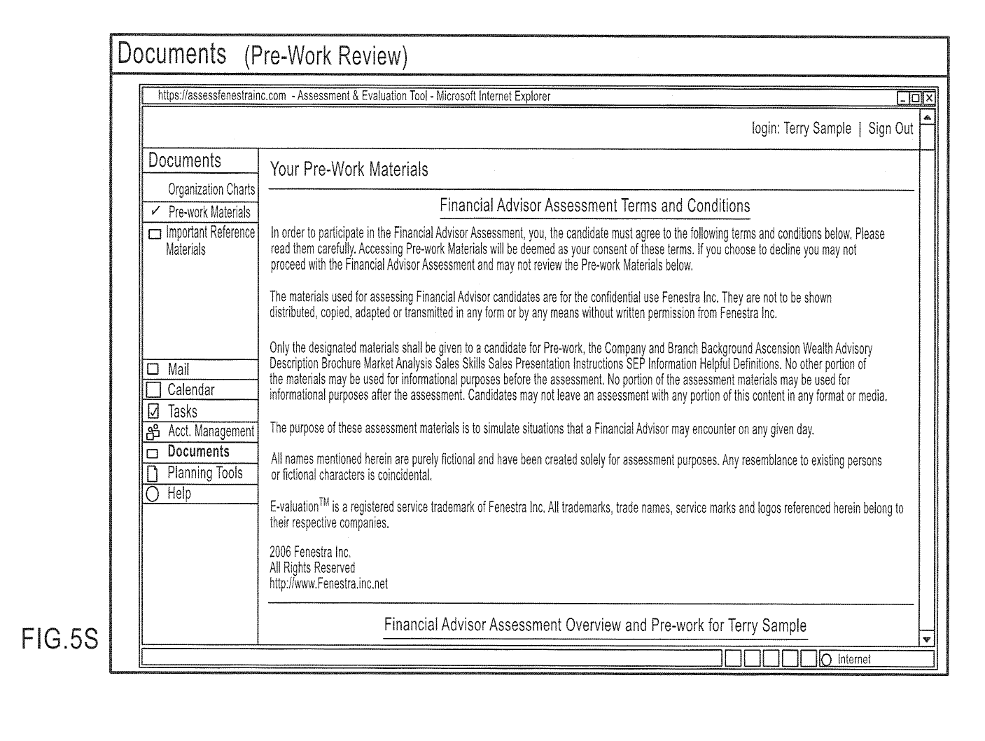

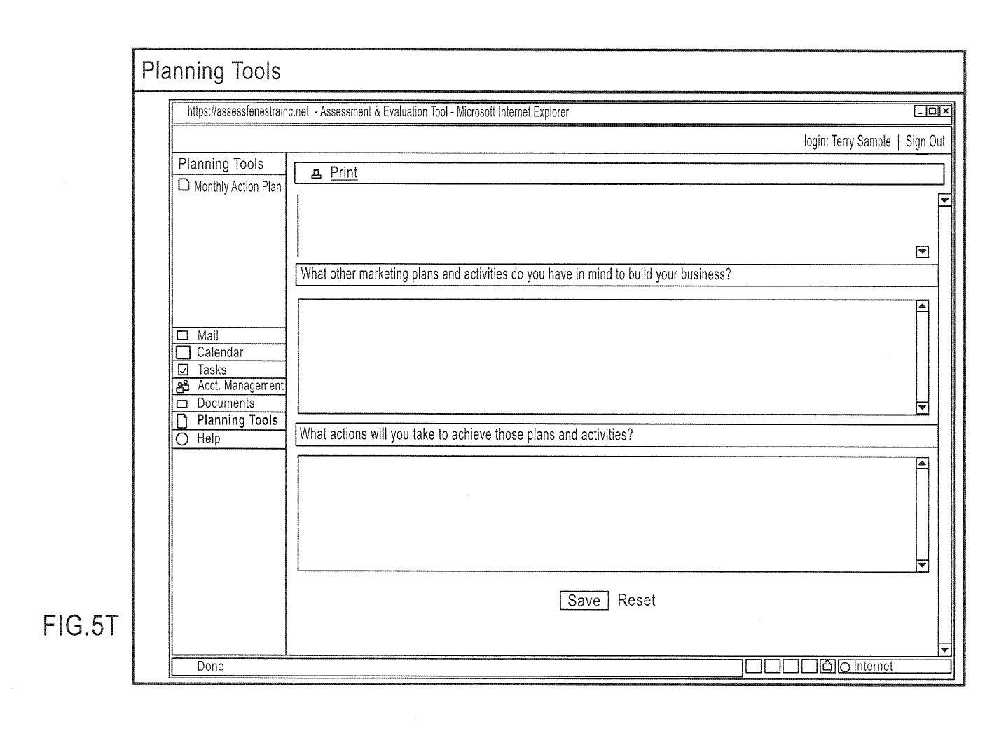

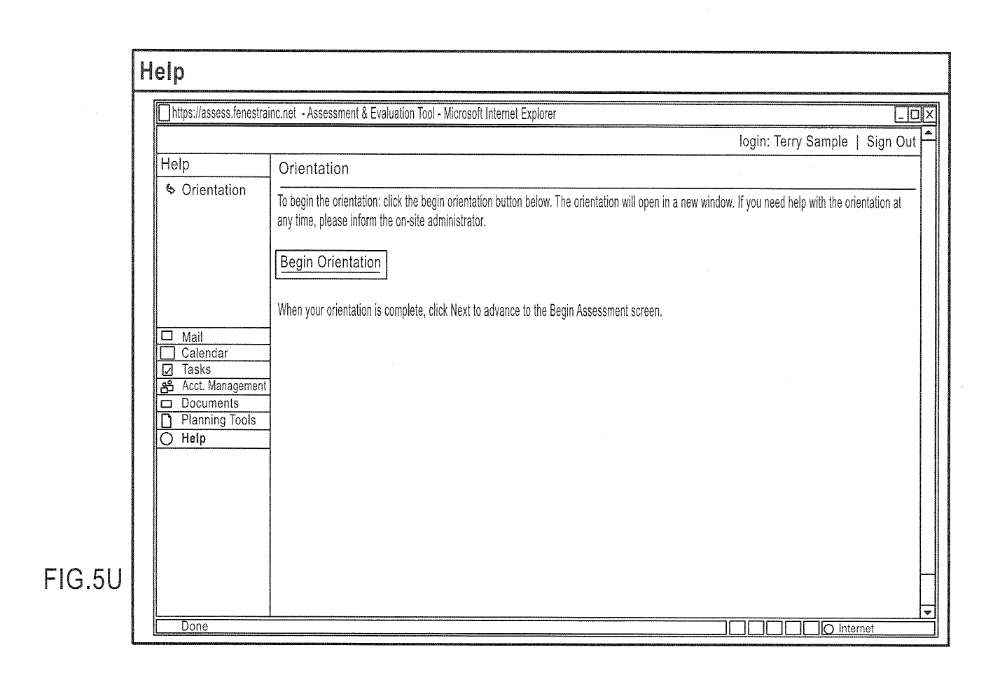

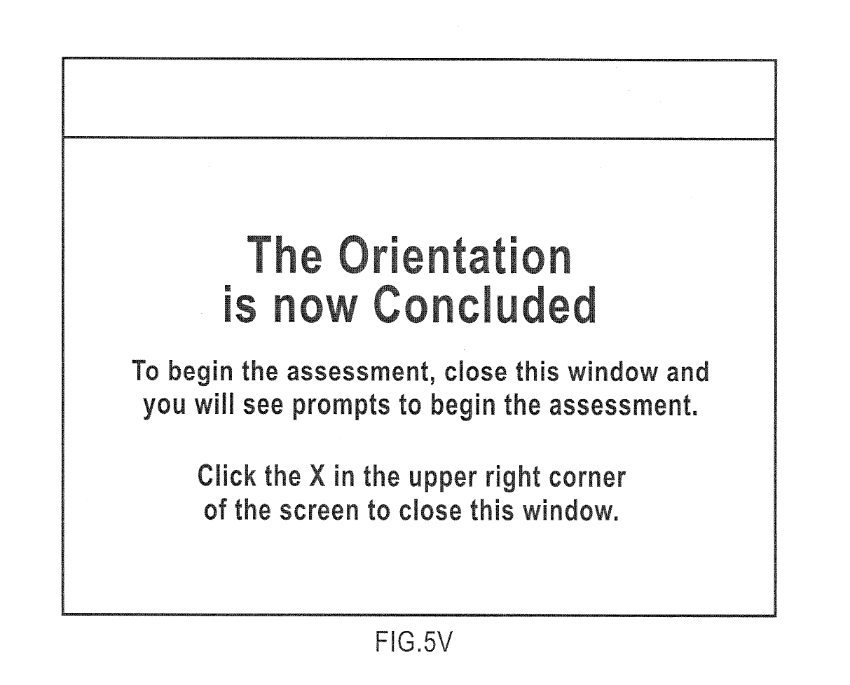

Assessment day instructions are provided to the candidate 418. The candidate is supplied with assessment preparation materials, which may include a virtual office, simulated company and market background information, position description and instructions for role playing with third party assessors (optional), and at least a telephone. A web-based orientation presentation may also be performed 420, which may include instructions for using the desktop and other relevant information. The results of the orientation may be loaded into the results database 420. Sample GUI screens for an exemplary web-based orientation, in accordance with one embodiment of the present invention, are shown in FIGS. 5A to 5V.

Referring again to FIG. 4, orientation results and progress are uploaded into the results database or other repository of data 420.

The technology-enhanced simulation is administered and observed in real time 422. The simulation may include work with simulated business tools, such as email, calendar, planners, contact logs, and company financial and strategy documents. The simulation may also include work with a personalized electronic in-basket, including email, business plans, personnel records and/or client accounts. As part of the simulation, the candidate may initiate and receive telephone calls, for example. In addition, part of the simulated “day in the life” may include scheduled and unscheduled meetings and role plays simulating on-the-job activities, in which the candidate is expected to participate. The meetings may be presented on-line (via computer), over the telephone (e.g., conference calls), or face-to-face with assessors, employers, other candidates, or actors, for example.

The candidate(s) are observed and evaluated by trained assessors in real-time throughout the day 422. In one embodiment, the observation and evaluation may include real-time tracking of candidate behavior and behavioral analyses of competency strengths and development needs. Candidates' actions may be evaluated by the assessors in relation to the relevant competencies, for example. Assessors may gauge the effectiveness of decisions and/or the quality of candidate solutions, the effectiveness of the candidate's overall operating style, and the candidate's behavior against the critical competencies.

Assessors used to evaluate candidate performance are experienced in the field to which the customized assessment is directed, for example. In addition, assessors may include individuals holding Masters Degrees, JDs, MBAs, Ph.D.s, and/or multiple other degrees and licenses. Assessors may also specialize in such fields as: individual and group assessment and development; 360-degree administration, qualitative and quantitative interpretation, and feedback delivery; mentoring; conflict negotiation/mediation; leader/transitional coaching; global leadership training; skill building; career planning and development; and change leadership. Assessors may be certified in administering and interpreting various tests, such as personality type indicators, emotional intelligence tests and leadership potential tests. Thus, a wide variety of relevant feedback reports from multiple perspectives may be generated, thereby providing a complete evaluation of candidate's skills, shortcomings, strengths and weaknesses, and a comprehensive evaluation and action plan regarding the candidate may be produced.

Assessors enter evaluations using on-line evaluation forms. The on-line evaluations are provided in real time 424. For example, the client may have immediate remote access to the evaluations, stored in the results database, and remotely available to the client 428. The assessor evaluations are integrated, and a comprehensive evaluation is compiled 426.

In one embodiment, based on the evaluations, a management feedback report is generated, with recommendations for selection, development planning, and ongoing talent management 426. Other reports may also be generated, including customized competency and behavioral-based feedback reports for candidates. In addition, a professional development plan may formulated for each candidate, based on constructive, behavioral, and actionable feedback, with developmental recommendations obtained via the assessment. In addition, aggregate reports of data may be generated, which may be useful for multiple human resources (HR) information systems and HR planning.

The client may have access to all of the evaluations and reports via the online database or other data repository 428. Hard copies of the evaluations and reports may also be provided.

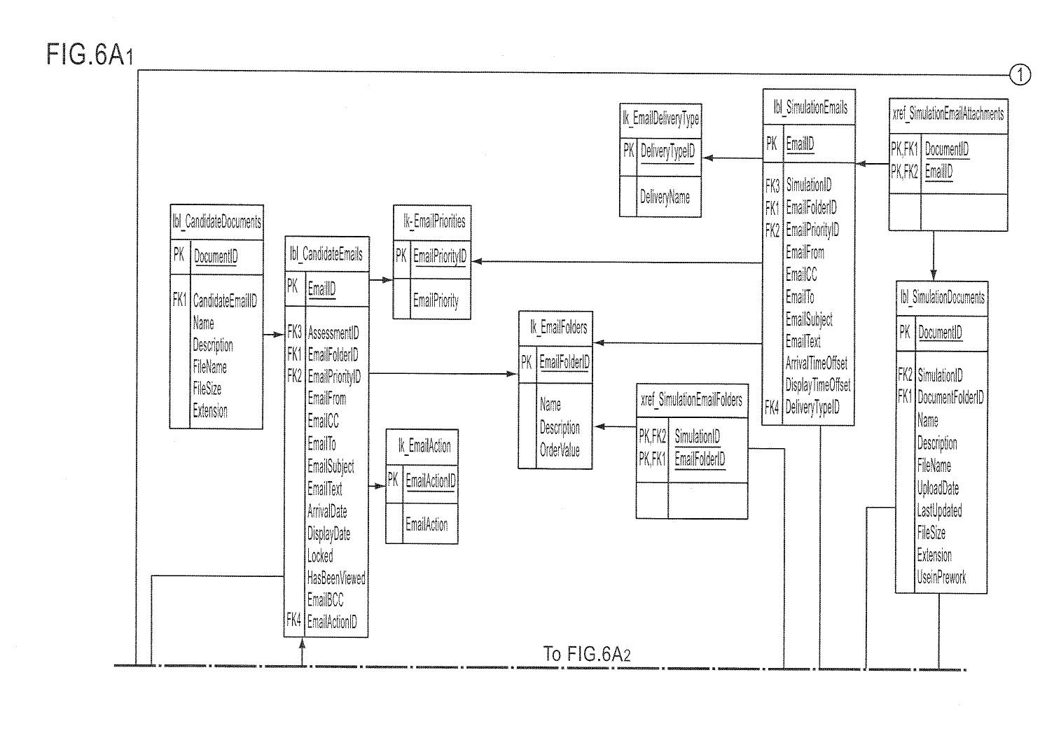

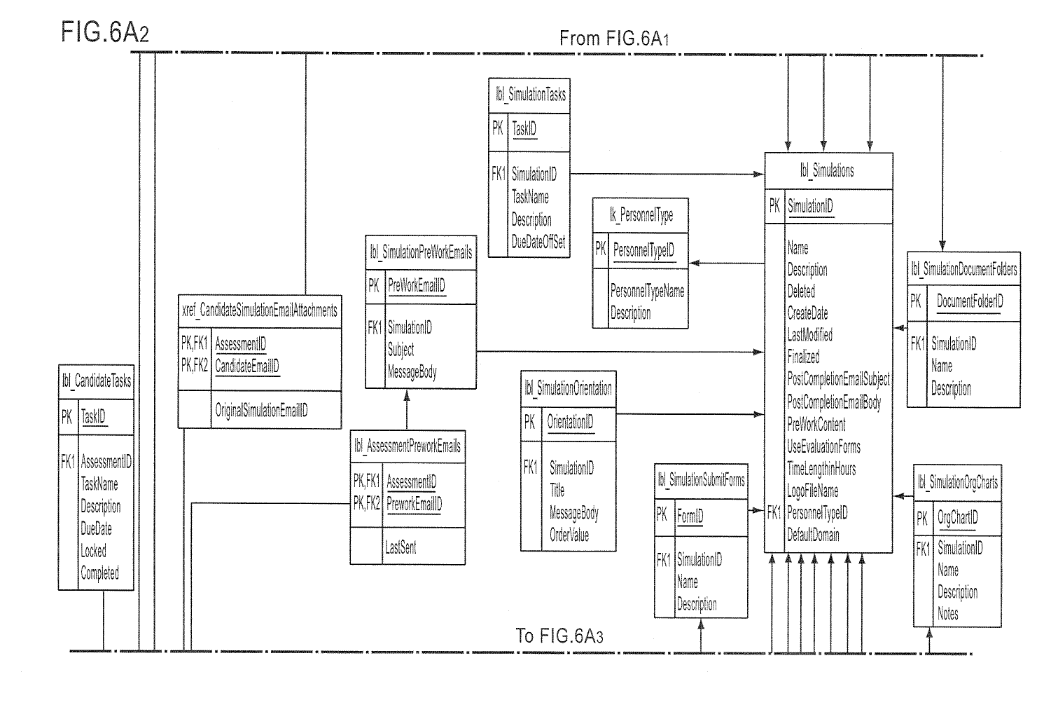

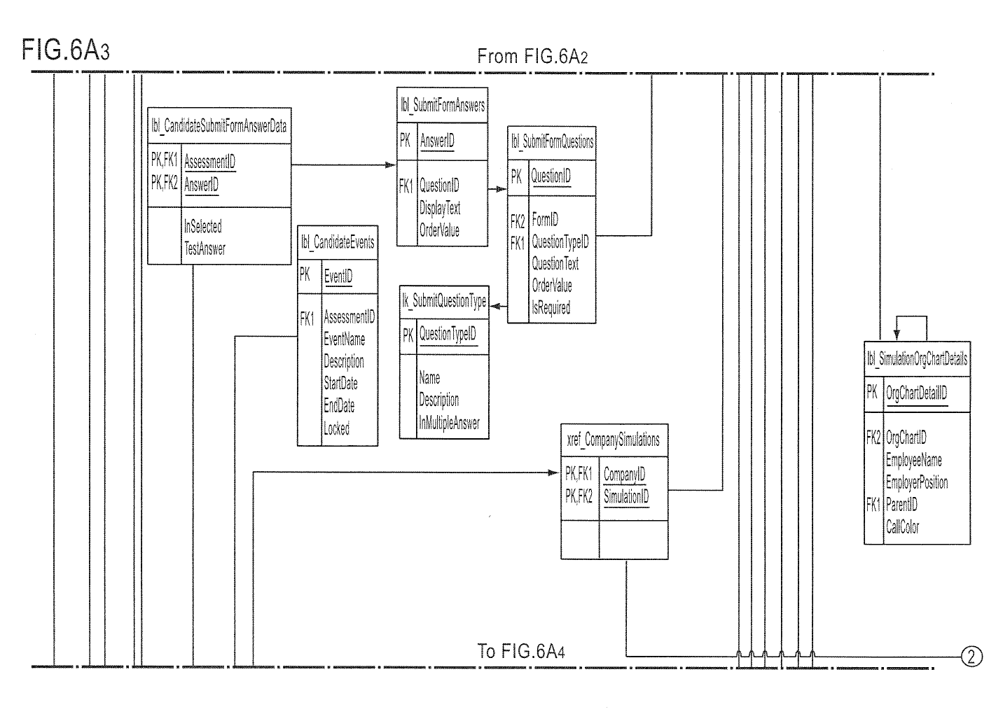

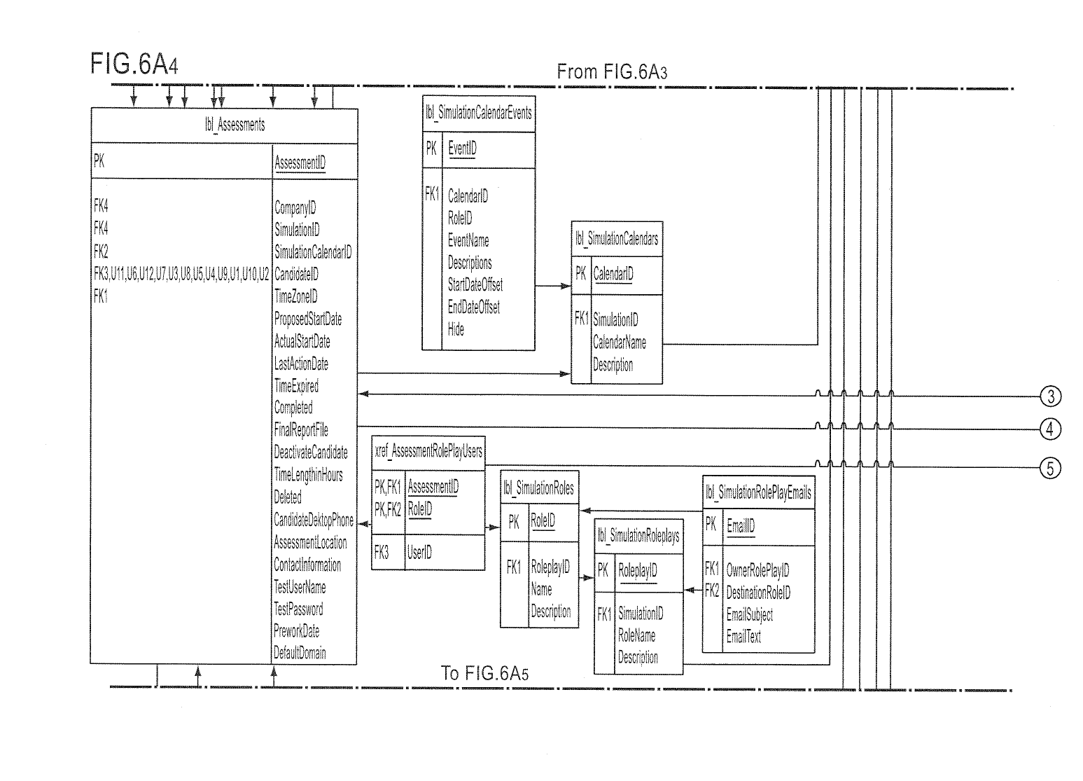

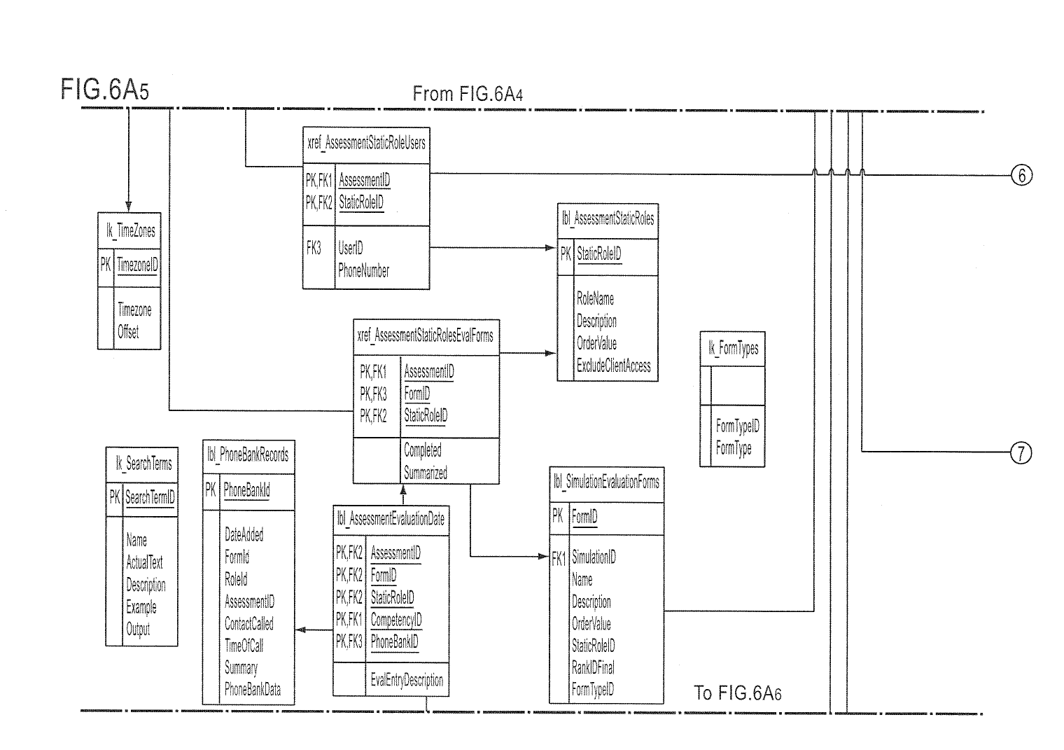

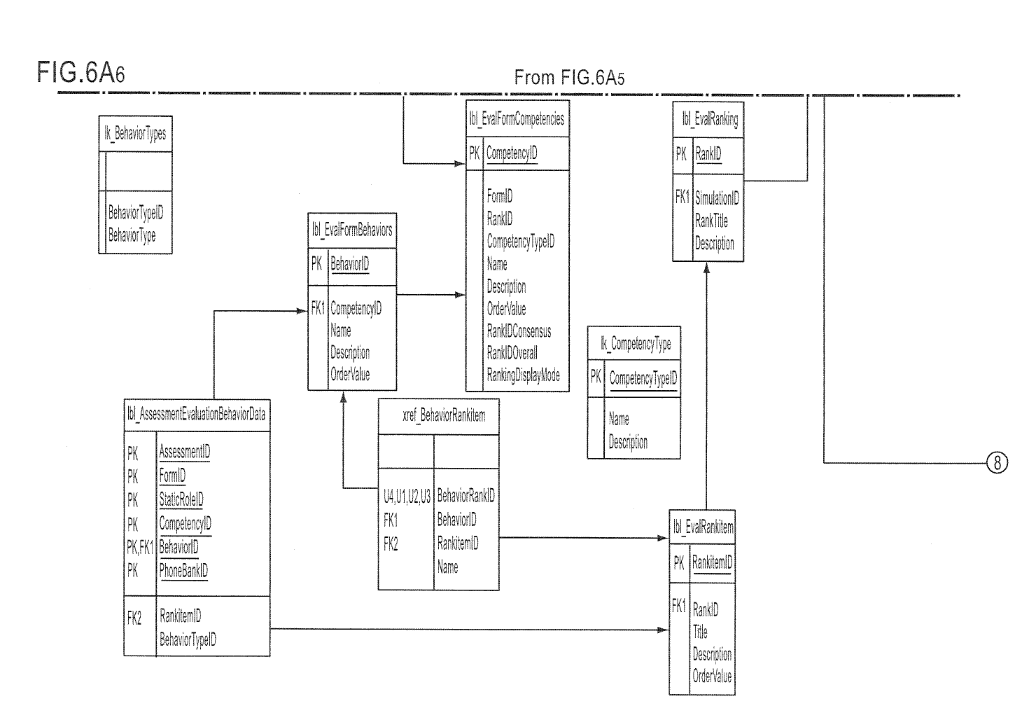

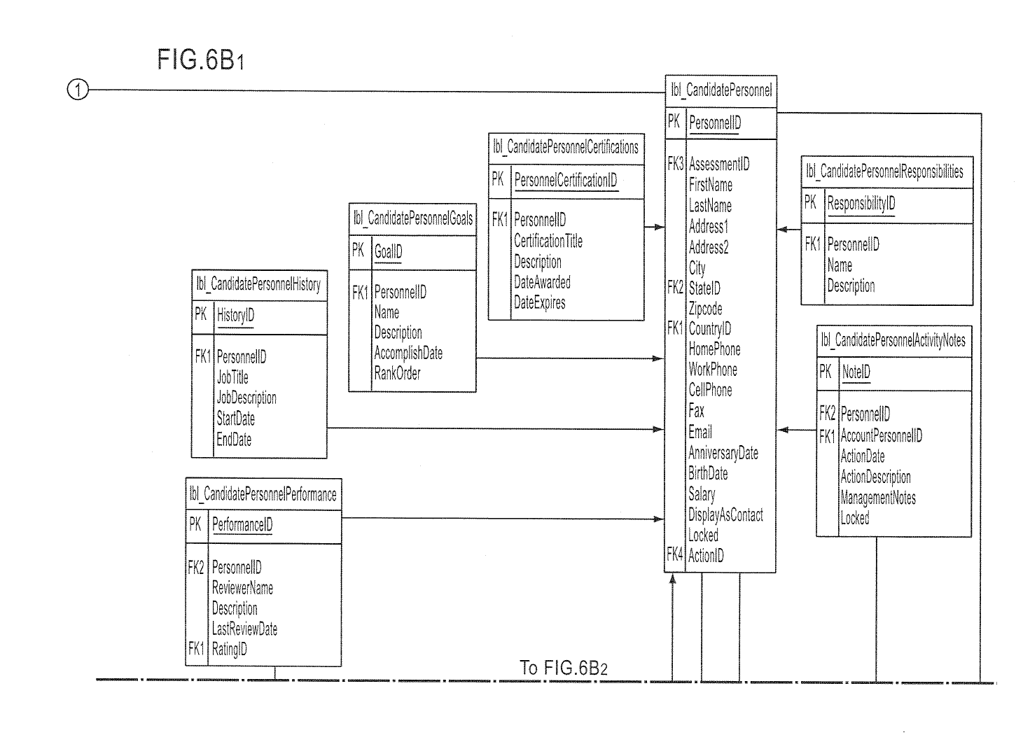

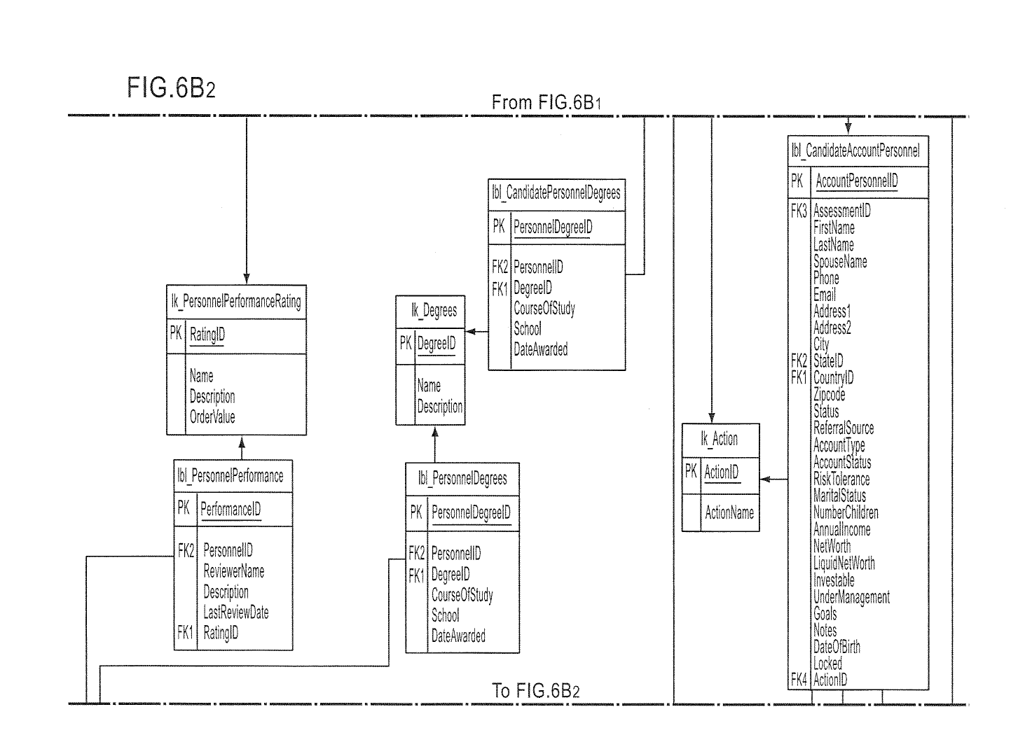

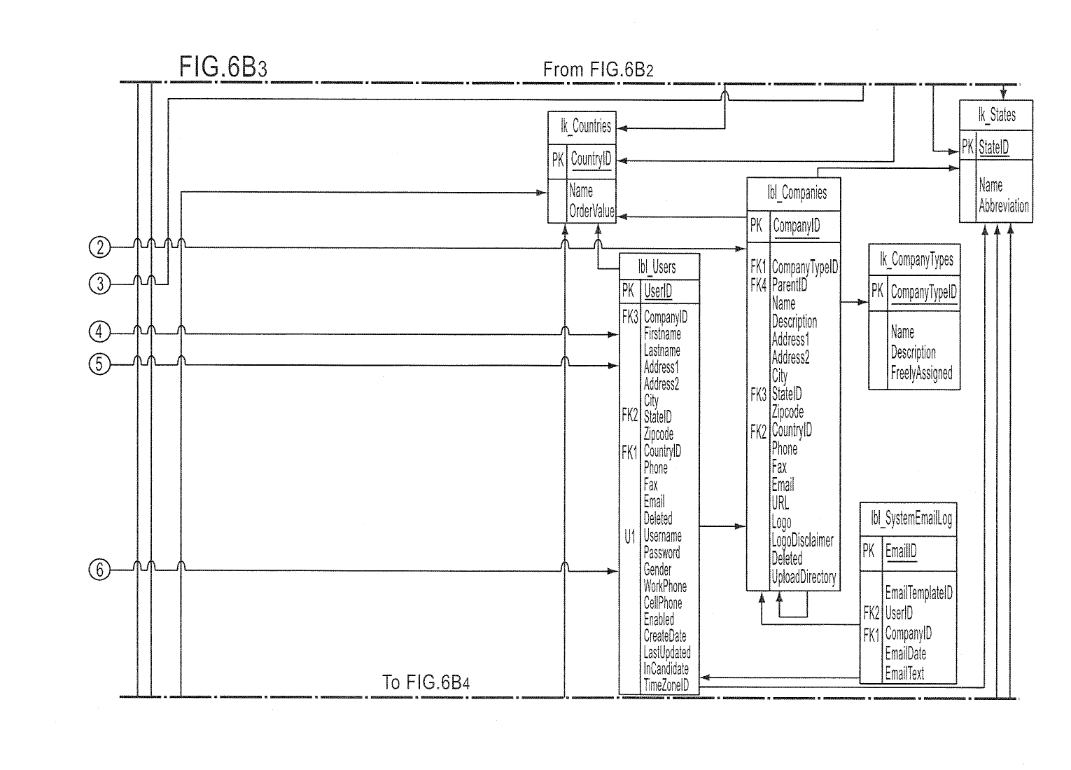

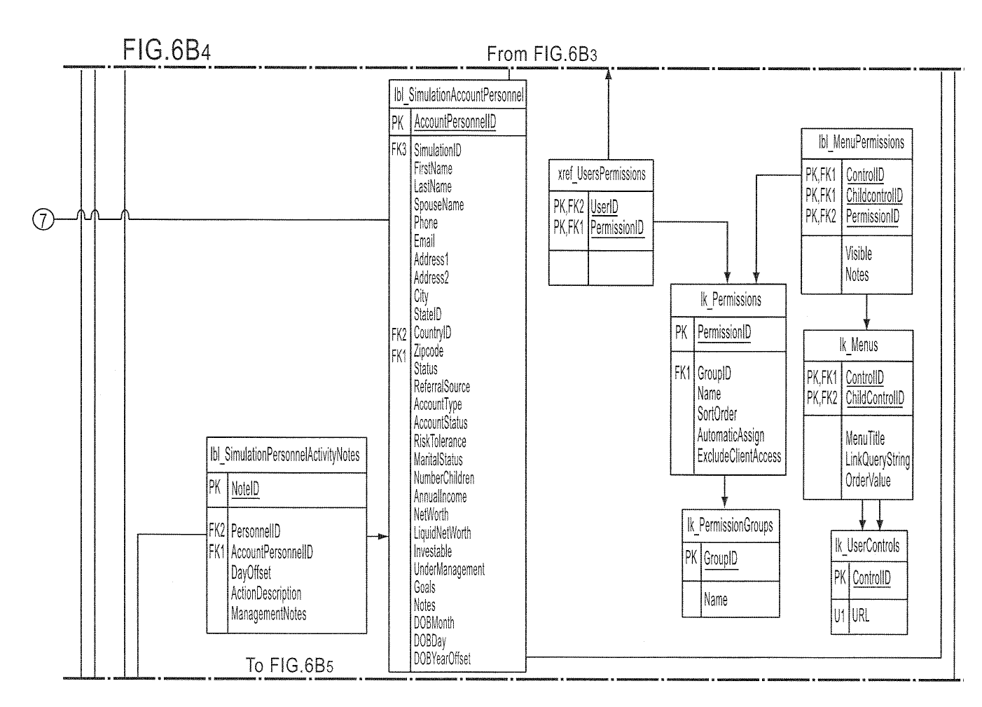

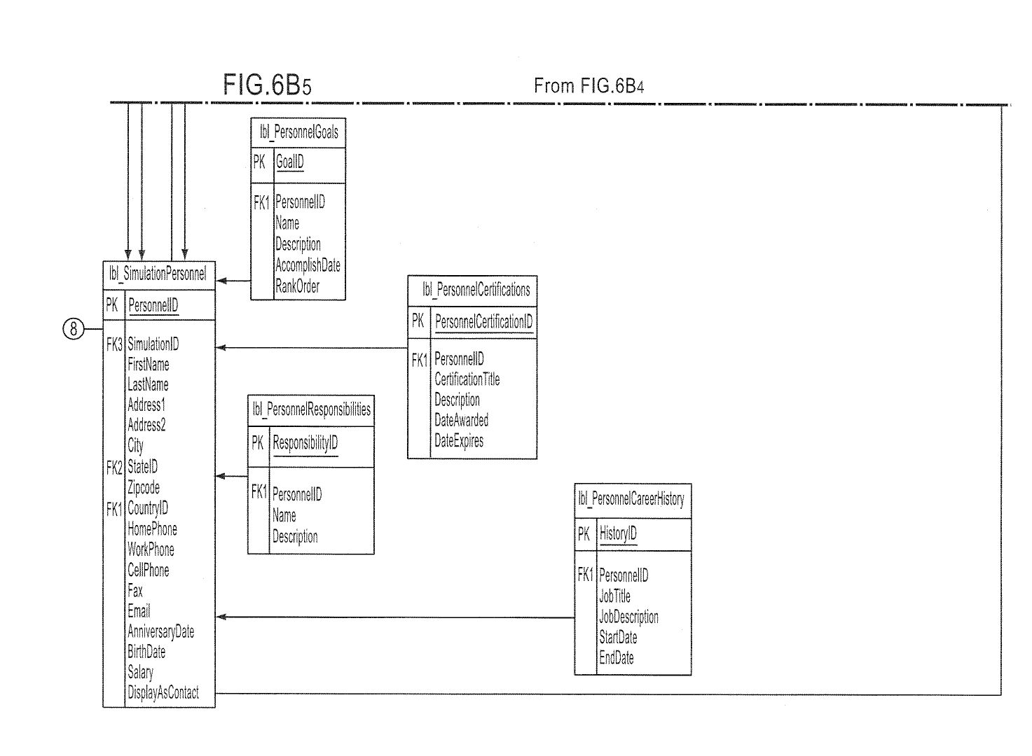

In accordance with one embodiment, electronic assessment information and client data is secured on local servers with nightly tape drive or other backup and full virus protection. Full backups may be performed weekly, for example. All client data is protected using, for example, a multi-tiered Windows 2003-based permissioning system, allowing data access on an as-needed basis only. Servers may be kept in a locked, guarded facility to protect client data. The databases, programs and technology enhanced software may be similarly stored. An exemplary on-line database or other repository of data for use in accordance with one embodiment of the present invention is shown in FIGS. 6A and 6B.

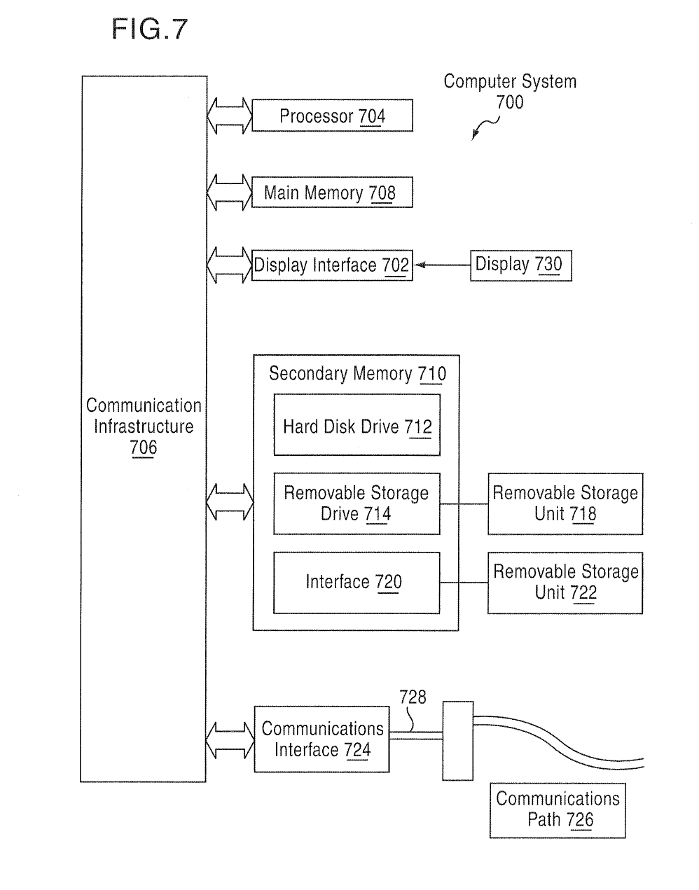

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system 700 is shown in FIG. 7.

Computer system 700 includes one or more processors, such as processor 704. The processor 704 is connected to a communication infrastructure 706 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 700 can include a display interface 702 that forwards graphics, text, and other data from the communication infrastructure 706 (or from a frame buffer not shown) for display on a display unit 730. Computer system 700 also includes a main memory 708, preferably random access memory (RAM), and may also include a secondary memory 710. The secondary memory 710 may include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc., which is read by and written to removable storage drive 714. As will be appreciated, the removable storage unit 718 includes a computer usable storage medium having stored therein computer software and/or data.

In alternative embodiments, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728, which may be electronic, electromagnetic, optical or other signals capable of being received by communications interface 724. These signals 728 are provided to communications interface 724 via a communications path (e.g., channel) 726. This path 726 carries signals 728 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 780, a hard disk installed in hard disk drive 770, and signals 728. These computer program products provide software to the computer system 700. The invention is directed to such computer program products.

Computer programs (also referred to as computer control logic) are stored in main memory 708 and/or secondary memory 710. Computer programs may also be received via communications interface 724. Such computer programs, when executed, enable the computer system 700 to perform the features of the present invention, as discussed herein. In particular, the computer programs, when executed, enable the processor 710 to perform the features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 720. The control logic (software), when executed by the processor 704, causes the processor 704 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

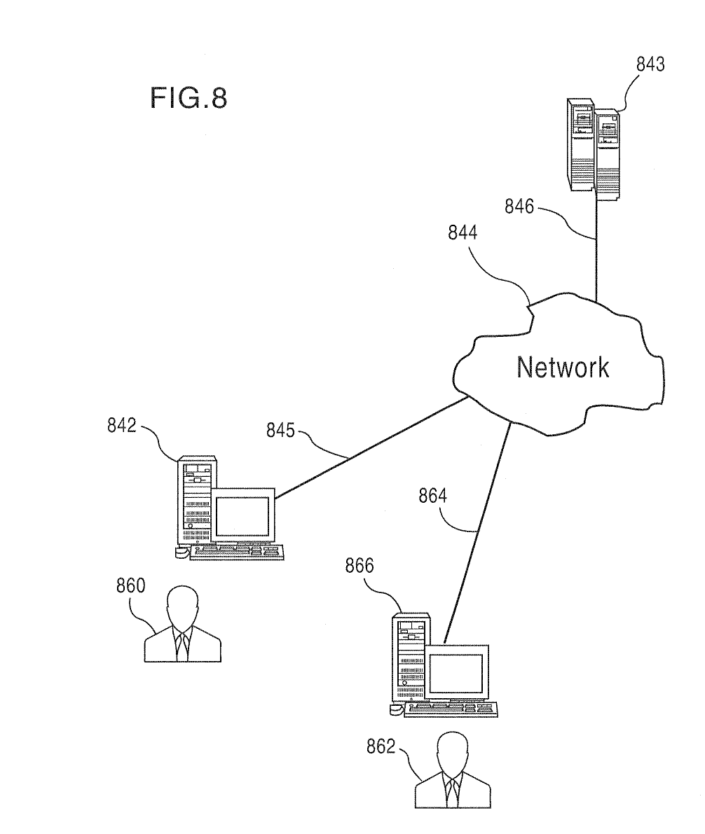

FIG. 8 shows a communication system 800 usable in accordance with the present invention. The communication system 800 includes one or more accessors 860, 862 (also referred to interchangeably herein as one or more “users”) and one or more terminals 842, 866. In one embodiment, data for use in accordance with the present invention is, for example, input and/or accessed by accessors 860, 864 via terminals 842, 866, such as personal computers (PCs), minicomputers, mainframe computers, microcomputers, telephonic devices, or wireless devices, such as personal digital assistants (“PDAs”) or hand-held wireless devices coupled to a server 843, such as a PC, minicomputer, mainframe computer, microcomputer, or other device having a processor and a repository for data and/or connection to a repository for data, via, for example, a network 844, such as the Internet or an intranet, and couplings 845, 846, 864. The couplings 845, 846, 864 include, for example, wired, wireless, or fiberoptic links. In another embodiment, the method and system of the present invention operate in a stand-alone environment, such as on a single terminal.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein.

1. A method for technology-enhanced assessment simulation, the method comprising:
receiving information for a participant;
transmitting an assessment invitation to the participant;
observing the participant engage in an assessment simulation;
providing assessment analysis based on the observed simulation; and
generating a report based on the assessment analysis.

2. The method of claim 1, further comprising:
administering testing.

3. The method of claim 1, wherein the observed simulation includes one selected from a group consisting of taking action based on an electronic in-basket and performing role plays.

4. The method of claim 1, wherein the assessment analysis includes one selected from a group consisting of a promotion decision, a succession identification, and a hiring decision.

5. The method of claim 1, wherein the generated report includes one selected from a group consisting of development planning and ongoing talent management.

6. The method of claim 2, wherein the testing includes one selected from a group consisting of personality testing and cognitive testing.

7. A method for technology-enhanced assessment simulation, the method comprising:
receiving an assessment request from a requester;
receiving candidate information;
generating assessment materials and a simulated work environment;
transmitting an assessment invitation to a candidate;
providing assessment day instructions to the candidate;
uploading candidate orientation results into a results database;
observing the candidate engage in assessment simulation;
providing real-time evaluations of the candidate; and
integrating evaluations.

8. The method of claim 7, further comprising:
establishing an assessment date.

9. The method of claim 7, further comprising:
transmitting assessment simulation participation instructions to the requester; and
transmitting master schedule to the requester.

10. The method of claim 7, further comprising:
uploading the candidate's pre-work test results into the results database.

11. The method of claim 7, further comprising:
uploading the integrated evaluations into the results database.

12. A web-based system for technology-enhanced assessment, the system comprising:
an assessment center pre-work component;
an individual assessment component;
an evaluation process component; and
an outcome component.

13. The system of claim 12, wherein the individual assessment component includes a simulation of an actual activity.

14. A system for technology-enhanced assessment simulation, the system comprising:
a receiver for receiving information for a participant;
a transmitter for transmitting an assessment invitation to the participant;
a viewer for observing the participant engage in an assessment simulation;
a transmitter for transmitting assessment analysis based on the observed simulation; and
a report generator for generating a report based on the assessment analysis.

15. The system of claim 14, wherein the observed simulation includes one selected from a group consisting of taking action based on an electronic in-basket and performing role plays.

16. The system of claim 14, wherein the assessment analysis includes one selected from a group consisting of a promotion decision, a succession identification, and a hiring decision.

17. The system of claim 14, wherein the generated report includes one selected from a group consisting of development planning and ongoing talent management.

18. A computer program product comprising a computer usable medium having control logic stored thereon for causing a computer to perform technology-enhanced assessment simulation, the control logic comprising:
first computer readable program code means for receiving information for a participant;
second computer readable program code means for transmitting an assessment invitation to the participant;
third computer readable program code means for observing the participant engage in an assessment simulation;
fourth computer readable program code means for transmitting assessment analysis based on the observed simulation; and
fifth computer readable program code means for generating a report based on the assessment analysis.

19. The computer program product of claim 18, the control logic further comprising:
sixth computer readable program code means for administering testing.

20. The computer program product of claim 18, wherein the observed simulation includes one selected from a group consisting of taking action based on an electronic in-basket and performing role plays.

21. The computer program product of claim 18, wherein the assessment analysis includes one selected from a group consisting of a promotion decision, a succession identification, and a hiring decision.

22. The computer program product of claim 18, wherein the generated report includes one selected from a group consisting of development planning and ongoing talent management.
